(19) United States
(12) Patent Application Publication
(10) Pub. No.: US 2023/0300836 A1
(43) Pub. Date: Sep. 21, 2023

(54) REFERENCE SIGNAL DROPPING WITH REGARDS TO HIGH PRIORITY CHANNEL COLLISIONS

(71) Applicant: QUALCOMM Incorporated, San Diego, CA (US)

(72) Inventors: Alexandros MANOLAKOS, Escondido, CA (US); Seyedkianoush HOSSEINI, San Diego, CA (US); Alberto RICO ALVARINO, San Diego, CA (US)

(21) Appl. No.: 18/004,171

(22) PCT Filed: Sep. 1, 2021
(86) PCT No.: PCT/US2021/048683

§ 371 Date: Jan. 3, 2023

(30) Foreign Application Priority Data
Sep. 4, 2020 (GR) 20200100536

(51) Int. Cl. H04W 72/1273; H04W 72/566; H04L 5/00

(52) U.S. Cl. CPC H04W 72/1273; H04L 5/0051; H04W 72/566

(57) ABSTRACT

Methods, systems, and devices for wireless communications are described. A user equipment (UE) may identify a switching rule pertaining to either carrier switching or antenna switching associated with the UE performing a reference signal transmission scheduled on a second carrier. The UE may receive a grant scheduling a downlink data transmission on a first carrier, the downlink data transmission comprising a priority level satisfying a priority threshold. The UE may determine that the reference signal transmission is scheduled on the second carrier within a time threshold of the downlink data transmission on the first carrier. The UE may monitor for the downlink data transmission instead of performing the reference signal transmission based at least in part on the switching rule and the priority level of the downlink data transmission satisfying the priority threshold.

### CROSS REFERENCE

The present Application is a 371 national stage filing of International PCT Application No. PCT/US2021/048683 by MANOLAKOS et al. entitled “REFERENCE SIGNAL DROPPING WITH REGARDS TO HIGH PRIORITY CHANNEL COLLISIONS,” filed Sep. 01, 2021, and claims priority to Greece Patent Application No. 20200100536 by MANOLAKOS et al. entitled “REFERENCE SIGNAL DROPPING WITH REGARDS TO HIGH PRIORITY CHANNEL COLLISIONS,” filed Sep. 04, 2020, each of which is assigned to the assignee hereof, and each of which is expressly incorporated by reference in its entirety herein.

### FIELD OF TECHNOLOGY

The following relates to wireless communications, including reference signal dropping with regards to high priority channel collisions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support reference signal dropping with regards to high priority channel collisions. Generally, the described techniques provide for various techniques that configure a switching rule to be adopted when a high priority downlink data transmission overlaps, at least to some degree, with a scheduled reference signal transmission on a different carrier. For example, a base station may transmit control information to a user equipment (UE) configuring a switching rule to be applied when the UE, in a carrier switching (CS) and/or antenna switching (AS) scenario, is scheduled to perform a reference signal transmission (e.g., a sounding reference signal (SRS) transmission) that at least partially overlaps with the downlink data transmission. The switching rule may be based on the overlap and the priority level of the downlink data transmission. For example, a high priority physical downlink shared channel (PDSCH) transmission (e.g., a downlink data transmission having a priority level satisfying a threshold) may be favored over the SRS transmission. The switching rule may be applied in a CS scenario where the high priority PDSCH and the SRS are on separate carriers. The priority rule may also be applied in an AS scenario where the high priority PDSCH and SRS are on separate carriers that “switch together” (e.g., as an antenna switching carrier set), meaning that if an antenna on one carrier switches, an antenna on the other carrier will also switch.

Generally, the described techniques provide for a reconfigurable switching rule that can be reconfigured to favor a high priority uplink transmission (e.g., a physical uplink shared channel (PUSCH) transmission) over an SRS transmission scheduled on a separate carrier. For example, the base station may also transmit control information to the UE configuring a reconfigurable switching rule that can be updated (e.g., reconfigured) by the base station as needed, periodically, etc. For example, the base station may configure the UE with a switching rule favoring a high priority PUSCH over an overlapping SRS transmission or with a switching rule favoring the SRS transmission over the high priority PUSCH.

A method of wireless communication at a UE is described. The method may include identifying a switching rule pertaining to either CS or AS associated with the UE performing a reference signal transmission scheduled on a second carrier, receiving a grant scheduling a downlink data transmission on a first carrier, the downlink data transmission including a priority level satisfying a priority threshold, determining that the reference signal transmission is scheduled on the second carrier within a time threshold of the downlink data transmission on the first carrier, and receiving the downlink data transmission instead of performing the reference signal transmission based on the switching rule and the priority level of the downlink data transmission satisfying the priority threshold.

An apparatus for wireless communication at a UE is described. The apparatus may include a processor, memory coupled with the processor, and instructions stored in the memory. The instructions may be executable by the processor to cause the apparatus to identify a switching rule pertaining to either CS or AS associated with the UE performing a reference signal transmission scheduled on a second carrier, receive a grant scheduling a downlink data transmission on a first carrier, the downlink data transmission including a priority level satisfying a priority threshold, determine that the reference signal transmission is scheduled on the second carrier within a time threshold of the downlink data transmission on the first carrier, and receive the downlink data transmission instead of performing the reference signal transmission based on the switching rule and the priority level of the downlink data transmission satisfying the priority threshold.

Another apparatus for wireless communication at a UE is described. The apparatus may include means for identifying a switching rule pertaining to either CS or AS associated with the UE performing a reference signal transmission scheduled on a second carrier, receiving a grant scheduling a downlink data transmission on a first carrier, the downlink data transmission including a priority level satisfying a priority threshold, determining that the reference signal transmission is scheduled on the second carrier within a time threshold of the downlink data transmission on the first carrier, and receiving the downlink data transmission instead of performing the reference signal transmission based on the switching rule and the priority level of the downlink data transmission satisfying the priority threshold.

A non-transitory computer-readable medium storing code for wireless communication at a UE is described. The code may include instructions executable by a processor to identify a switching rule pertaining to either CS or AS associated with the UE performing a reference signal transmission scheduled on a second carrier, receive a grant scheduling a downlink data transmission on a first carrier, the downlink data transmission including a priority level satisfying a priority threshold, determine that the reference signal transmission is scheduled on the second carrier within a time threshold of the downlink data transmission on the first carrier, and receive the downlink data transmission instead of performing the reference signal transmission based on the switching rule and the priority level of the downlink data transmission satisfying the priority threshold.

Some examples of the method, apparatuses, and non-transitory computer-readable medium described herein may further include operations, features, means, or instructions for determining that the grant may be received in advance of the UE performing the reference signal transmission scheduled on the second carrier by at least a switching decision threshold amount of time, where receiving the downlink data transmission instead of performing the reference signal transmission may be based on the grant being received before the UE may be scheduled to perform the reference signal transmission by at least the switching decision threshold.

In some examples of the method, apparatuses, and non-transitory computer-readable medium described herein, identifying the switching rule may include operations, features, means, or instructions for receiving an indication that the switching rule pertains to CS between the first carrier and the second carrier for UE to perform the reference signal transmission on the second carrier.

Some examples of the method, apparatuses, and non-transitory computer-readable medium described herein may further include operations, features, means, or instructions for identifying a switching time associated with the UE switching from the first carrier to the second carrier, from the second carrier back to the first carrier, or both, where determining that the reference signal transmission may be scheduled within the time threshold may be based on the switching time.

Some examples of the method, apparatuses, and non-transitory computer-readable medium described herein may further include operations, features, means, or instructions for determining that at least one of a switching time associated with the UE switching from the first carrier to the second carrier, the reference signal transmission, or a switching time associated with the UE switching from the second carrier to the first carrier after the reference signal transmission may be scheduled at least partially overlaps the downlink data transmission, where determining that the reference signal transmission may be scheduled within the time threshold may be based on the switching time at least partially overlapping with the downlink data transmission.

In some examples of the method, apparatuses, and non-transitory computer-readable medium described herein, identifying the switching rule may include operations, features, means, or instructions for receiving an indication that the switching rule pertains to AS, where the first carrier and the second carrier include an AS carrier set such that switching of antennas associated with the second carrier causes switching of antennas associated with the first carrier.

Some examples of the method, apparatuses, and non-transitory computer-readable medium described herein may further include operations, features, means, or instructions for determining that the reference signal transmission includes a set of reference signal transmissions on the second carrier, and determining that at least one of the set of reference signal transmissions on the second carrier at least partially overlaps the downlink data transmission, where determining that the reference signal transmission may be scheduled within the time threshold may be based on the at least one of the set of reference signal transmissions at least partially overlapping with the downlink data transmission.

Some examples of the method, apparatuses, and non-transitory computer-readable medium described herein may further include operations, features, means, or instructions for determining that the reference signal transmission includes a set of reference signal transmissions on the second carrier, identifying a first subset of reference signal transmissions in the set of reference signal transmissions that may be scheduled in nonoverlapping resources of the downlink data transmission, and identifying a second subset of reference signal transmissions in the set of reference signal transmissions that may be scheduled in at least partially overlapping resources of the downlink data transmission, where receiving the downlink data transmission instead of performing the reference signal transmission includes performing the first subset of reference signal transmissions but refraining from performing the second subset of reference signal transmissions.

Some examples of the method, apparatuses, and non-transitory computer-readable medium described herein may further include operations, features, means, or instructions for receiving a second grant scheduling a second downlink data transmission on the first carrier, the second downlink data transmission including a second priority level that fails to satisfy the priority threshold, determining that a second reference signal transmission may be scheduled on the second carrier within the time threshold of the second downlink data transmission, and performing the second reference signal transmission instead of performing the second downlink data transmission based on the switching rule and the second priority level failing to satisfy the priority threshold.

In some examples of the method, apparatuses, and non-transitory computer-readable medium described herein, the switching rule includes a CS rule, an AS rule, or both.

In some examples of the method, apparatuses, and non-transitory computer-readable medium described herein, the reference signal transmission includes an SRS transmission.

A method of wireless communication at a UE is described. The method may include receiving a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission, receiving a grant scheduling an uplink transmission on the first carrier, the uplink transmission including the priority level satisfying the priority threshold, determining that the reference signal transmission is scheduled on the second carrier within a time threshold of the uplink transmission on the first carrier, and performing one of the reference signal transmission or the uplink transmission based on the switching rule and the priority level of the uplink transmission satisfying the priority threshold.

An apparatus for wireless communication at a UE is described. The apparatus may include a processor, memory coupled with the processor, and instructions stored in the memory. The instructions may be executable by the processor to cause the apparatus to receive a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission, receive a grant scheduling an uplink transmission on the first carrier, the uplink transmission including the priority level satisfying the priority threshold, determine that the reference signal transmission is scheduled on the second carrier within a time threshold of the uplink transmission on the first carrier, and perform one of the reference signal transmission or the uplink transmission based on the switching rule and the priority level of the uplink transmission satisfying the priority threshold.

Another apparatus for wireless communication at a UE is described. The apparatus may include means for receiving a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission, receiving a grant scheduling an uplink transmission on the first carrier, the uplink transmission including the priority level satisfying the priority threshold, determining that the reference signal transmission is scheduled on the second carrier within a time threshold of the uplink transmission on the first carrier, and performing one of the reference signal transmission or the uplink transmission based on the switching rule and the priority level of the uplink transmission satisfying the priority threshold.

A non-transitory computer-readable medium storing code for wireless communication at a UE is described. The code may include instructions executable by a processor to receive a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission, receive a grant scheduling an uplink transmission on the first carrier, the uplink transmission including the priority level satisfying the priority threshold, determine that the reference signal transmission is scheduled on the second carrier within a time threshold of the uplink transmission on the first carrier, and perform one of the reference signal transmission or the uplink transmission based on the switching rule and the priority level of the uplink transmission satisfying the priority threshold.

Some examples of the method, apparatuses, and non-transitory computer-readable medium described herein may further include operations, features, means, or instructions for prioritizing, based on the switching rule and the priority level of the uplink transmission satisfying the priority threshold, the reference signal transmission on the second carrier over the uplink transmission on the first carrier.

Some examples of the method, apparatuses, and non-transitory computer-readable medium described herein may further include operations, features, means, or instructions for prioritizing, based on the switching rule and the priority level of the uplink transmission satisfying the priority threshold, the uplink transmission on the first carrier over the reference signal transmission on the second carrier.

In some examples of the method, apparatuses, and non-transitory computer-readable medium described herein, the reference signal transmission includes an SRS transmission.

A method of wireless communication at a base station is described. The method may include identifying, for a UE, a switching rule pertaining to either CS or AS associated with the UE performing a reference signal transmission scheduled on a second carrier, transmitting a grant scheduling a downlink data transmission on a first carrier, the downlink data transmission including a priority level satisfying a priority threshold, determining that the reference signal transmission is scheduled on the second carrier within a time threshold of the downlink data transmission on the first carrier, and performing the downlink data transmission instead of monitoring for the reference signal transmission based on the switching rule and the priority level of the downlink data transmission satisfying the priority threshold.

An apparatus for wireless communication at a base station is described. The apparatus may include a processor, memory coupled with the processor, and instructions stored in the memory. The instructions may be executable by the processor to cause the apparatus to identify, for a UE, a switching rule pertaining to either CS or AS associated with the UE performing a reference signal transmission scheduled on a second carrier, transmit a grant scheduling a downlink data transmission on a first carrier, the downlink data transmission including a priority level satisfying a priority threshold, determine that the reference signal transmission is scheduled on the second carrier within a time threshold of the downlink data transmission on the first carrier, and perform the downlink data transmission instead of monitoring for the reference signal transmission based on the switching rule and the priority level of the downlink data transmission satisfying the priority threshold.

Another apparatus for wireless communication at a base station is described. The apparatus may include means for identifying, for a UE, a switching rule pertaining to either CS or AS associated with the UE performing a reference signal transmission scheduled on a second carrier, transmitting a grant scheduling a downlink data transmission on a first carrier, the downlink data transmission including a priority level satisfying a priority threshold, determining that the reference signal transmission is scheduled on the second carrier within a time threshold of the downlink data transmission on the first carrier, and performing the downlink data transmission instead of monitoring for the reference signal transmission based on the switching rule and the priority level of the downlink data transmission satisfying the priority threshold.

A non-transitory computer-readable medium storing code for wireless communication at a base station is described. The code may include instructions executable by a processor to identify, for a UE, a switching rule pertaining to either CS or AS associated with the UE performing a reference signal transmission scheduled on a second carrier, transmit a grant scheduling a downlink data transmission on a first carrier, the downlink data transmission including a priority level satisfying a priority threshold, determine that the reference signal transmission is scheduled on the second carrier within a time threshold of the downlink data transmission on the first carrier, and perform the downlink data transmission instead of monitoring for the reference signal transmission based on the switching rule and the priority level of the downlink data transmission satisfying the priority threshold.

Some examples of the method, apparatuses, and non-transitory computer-readable medium described herein may further include operations, features, means, or instructions for determining that the grant may be received by the UE in advance of the reference signal transmission scheduled on the second carrier by at least a switching decision threshold amount of time, where performing the downlink data transmission instead of monitoring for the reference signal transmission may be based on the grant being received before the UE may be scheduled to perform the reference signal transmission by at least the switching decision threshold.

Some examples of the method, apparatuses, and non-transitory computer-readable medium described herein may further include operations, features, means, or instructions for transmitting an indication that the switching rule pertains to CS between the first carrier and the second carrier for the UE to perform the reference signal transmission on the second carrier.

Some examples of the method, apparatuses, and non-transitory computer-readable medium described herein may further include operations, features, means, or instructions for identifying a switching time associated with the UE switching from the first carrier to the second carrier, from the second carrier back to the first carrier, or both, where determining that the reference signal transmission may be scheduled within the time threshold may be based on the switching time.

Some examples of the method, apparatuses, and non-transitory computer-readable medium described herein may further include operations, features, means, or instructions for determining that at least one of a switching time associated with the UE switching from the first carrier to the second carrier, the reference signal transmission, or a switching time associated with the UE switching from the second carrier to the first carrier after the reference signal transmission may be scheduled at least partially overlaps the downlink data transmission, where determining that the reference signal transmission may be scheduled within the time threshold may be based on the switching time at least partially overlapping with the downlink data transmission.

In some examples of the method, apparatuses, and non-transitory computer-readable medium described herein, identifying the switching rule may include operations, features, means, or instructions for transmitting an indication that the switching rule pertains to AS, where the first carrier and the second carrier may be an AS carrier set such that switching of antennas associated with the second carrier causes switching of antennas associated with the first carrier.

Some examples of the method, apparatuses, and non-transitory computer-readable medium described herein may further include operations, features, means, or instructions for determining that the reference signal transmission includes a set of reference signal transmissions on the second carrier, and determining that at least one of the set of reference signal transmissions on the second carrier at least partially overlaps the downlink data transmission, where determining that the reference signal transmission may be scheduled within the time threshold may be based on the at least one of the set of reference signal transmissions at least partially overlapping with the downlink data transmission.

Some examples of the method, apparatuses, and non-transitory computer-readable medium described herein may further include operations, features, means, or instructions for determining that the reference signal transmission includes a set of reference signal transmissions on the second carrier, identifying a first subset of reference signal transmissions in the set of reference signal transmissions that may be scheduled in non-overlapping resources of the downlink data transmission, and identifying a second subset of reference signal transmissions in the set of reference signal transmissions that may be scheduled in at least partially overlapping resources of the downlink data transmission, where performing the downlink data transmission instead of monitoring for the reference signal transmission includes monitoring for the first subset of reference signal transmissions but refraining from monitoring for the second subset of reference signal transmissions.

Some examples of the method, apparatuses, and non-transitory computer-readable medium described herein may further include operations, features, means, or instructions for transmitting a second grant scheduling a second downlink data transmission on the first carrier, the second downlink data transmission including a second priority level that fails to satisfy the priority threshold, determining that a second reference signal transmission by the UE may be scheduled on the second carrier within the time threshold of the second downlink data transmission, and monitoring for the second reference signal transmission instead of performing the second downlink data transmission based on the switching rule and the second priority level failing to satisfy the priority threshold.

In some examples of the method, apparatuses, and non-transitory computer-readable medium described herein, the switching rule includes a CS rule, an AS rule, or both.

In some examples of the method, apparatuses, and non-transitory computer-readable medium described herein, the reference signal transmission includes an SRS transmission.

A method of wireless communication at a base station is described. The method may include transmitting, to a UE, a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission, transmitting a grant scheduling an uplink transmission on the first carrier, the uplink transmission including the priority level satisfying the priority threshold, determining that the reference signal transmission is scheduled on the second carrier within a time threshold of the uplink transmission on the first carrier, and monitoring for one of the reference signal transmission or the uplink transmission based on the switching rule and the priority level of the uplink transmission satisfying the priority threshold.

An apparatus for wireless communication at a base station is described. The apparatus may include a processor, memory coupled with the processor, and instructions stored in the memory. The instructions may be executable by the processor to cause the apparatus to transmit, to a UE, a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission, transmit a grant scheduling an uplink transmission on the first carrier, the uplink transmission including the priority level satisfying the priority threshold, determine that the reference signal transmission is scheduled on the second carrier within a time threshold of the uplink transmission on the first carrier, and monitor for one of the reference signal transmission or the uplink transmission based on the switching rule and the priority level of the uplink transmission satisfying the priority threshold.

Another apparatus for wireless communication at a base station is described. The apparatus may include means for transmitting, to a UE, a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission, transmitting a grant scheduling an uplink transmission on the first carrier, the uplink transmission including the priority level satisfying the priority threshold, determining that the reference signal transmission is scheduled on the second carrier within a time threshold of the uplink transmission on the first carrier, and monitoring for one of the reference signal transmission or the uplink transmission based on the switching rule and the priority level of the uplink transmission satisfying the priority threshold.

A non-transitory computer-readable medium storing code for wireless communication at a base station is described. The code may include instructions executable by a processor to transmit, to a UE, a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission, transmit a grant scheduling an uplink transmission on the first carrier, the uplink transmission including the priority level satisfying the priority threshold, determine that the reference signal transmission is scheduled on the second carrier within a time threshold of the uplink transmission on the first carrier, and monitor for one of the reference signal transmission or the uplink transmission based on the switching rule and the priority level of the uplink transmission satisfying the priority threshold.

Some examples of the method, apparatuses, and non-transitory computer-readable medium described herein may further include operations, features, means, or instructions for prioritizing, based on the switching rule and the priority level of the uplink transmission the priority threshold, the reference signal transmission on the second carrier over the uplink transmission on the first carrier.

Some examples of the method, apparatuses, and non-transitory computer-readable medium described herein may further include operations, features, means, or instructions for prioritizing, based on the switching rule and the priority level of the uplink transmission satisfying the priority threshold, the uplink transmission on the first carrier over the reference signal transmission on the second carrier.

In some examples of the method, apparatuses, and non-transitory computer-readable medium described herein, the reference signal transmission includes an SRS transmission.

### BRIEF DESCRIPTION OF THE DRAWINGS

FIG. 1 illustrates an example of a system for wireless communications that supports reference signal dropping with regards to high priority channel collisions in accordance with aspects of the present disclosure.

FIG. 2 illustrates an example of a wireless communication system that supports reference signal dropping with regards to high priority channel collisions in accordance with aspects of the present disclosure.

FIG. 3 illustrates an example of a switching configuration that supports reference signal dropping with regards to high priority channel collisions in accordance with aspects of the present disclosure.

FIG. 4 illustrates an example of a switching configuration that supports reference signal dropping with regards to high priority channel collisions in accordance with aspects of the present disclosure.

FIG. 5 illustrates an example of a process that supports reference signal dropping with regards to high priority channel collisions in accordance with aspects of the present disclosure.

FIG. 6 illustrates an example of a process that supports reference signal dropping with regards to high priority channel collisions in accordance with aspects of the present disclosure.

FIGS. 7 and 8 show block diagrams of devices that support reference signal dropping with regards to high priority channel collisions in accordance with aspects of the present disclosure.

FIG. 9 shows a block diagram of a communications manager that supports reference signal dropping with regards to high priority channel collisions in accordance with aspects of the present disclosure.

FIG. 10 shows a diagram of a system including a device that supports reference signal dropping with regards to high priority channel collisions in accordance with aspects of the present disclosure.

FIGS. 11 and 12 show block diagrams of devices that support reference signal dropping with regards to high priority channel collisions in accordance with aspects of the present disclosure.

FIG. 13 shows a block diagram of a communications manager that supports reference signal dropping with regards to high priority channel collisions in accordance with aspects of the present disclosure.

FIG. 14 shows a diagram of a system including a device that supports reference signal dropping with regards to high priority channel collisions in accordance with aspects of the present disclosure.

FIGS. 15 through 19 show flowcharts illustrating methods that support reference signal dropping with regards to high priority channel collisions in accordance with aspects of the present disclosure.

### DETAILED DESCRIPTION

Some wireless communications systems may define switching rules for a user equipment (UE) to follow when the UE determines that an overlap occurs between the UE performing a sounding reference signal (SRS) transmission and an uplink data transmission on different carriers (e.g., using either carrier switching (CS) and/or antenna switching (AS)). For example, the switching rules currently define how the UE responds in such scenarios, with the UE either performing the SRS transmission and dropping the data transmission, or vice versa. However, there are currently no rules defined detailing how the UE will respond when an SRS transmission conflicts with a high priority downlink data transmission, such as a physical downlink shared channel (PDSCH) transmission. That is, current wireless communication systems do not provide a mechanism for the UE to determine whether to prioritize the high priority PDSCH reception or the SRS transmission in a carrier switching situation where the PDSCH and SRS at least partially overlap in time. Moreover, the switching rules currently defined are fixed in that they do not allow for modification, which limits the ability of the base station and/or UE to respond to changing communication environments.

Aspects of the disclosure are initially described in the context of wireless communications systems. Generally, the described techniques provide for various techniques that configure a switching rule to be adopted when a high priority downlink data transmission overlaps, at least to some degree, with a scheduled reference signal transmission on a different carrier. For example, a base station may transmit control information to a UE configuring a switching rule to be applied when the UE, in a CS and/or AS scenario, is scheduled to perform a reference signal transmission (e.g., an SRS transmission) that at least partially overlaps with the downlink data transmission. The switching rule may be based on the overlap and the priority level of the downlink data transmission. For example, a high priority PDSCH transmission (e.g., a downlink data transmission having a priority level satisfying a threshold) may be favored over the SRS transmission. The switching rule may be applied in a CS scenario where the high priority PDSCH and the SRS are on separate carriers. The priority rule may also be applied in an AS scenario where the high priority PDSCH and SRS are on separate carriers that “switch together” (e.g., as an antenna switching carrier set), meaning that if an antenna on one carrier switches, an antenna on the other carrier will also switch.

Generally, the described techniques provide for a reconfigurable switching rule that can be reconfigured to favor a high priority uplink transmission (e.g., a physical uplink shared channel (PUSCH) transmission) over an SRS transmission scheduled on a separate carrier. For example, the base station may also transmit control information to the UE configuring a reconfigurable switching rule that can be updated (e.g., reconfigured) by the base station as needed, periodically, etc. For example, the base station may configure the UE with a switching rule favoring a high priority PUSCH over an overlapping SRS transmission or with a switching rule favoring the SRS transmission over the high priority PUSCH.

Aspects of the disclosure are further illustrated by and described with reference to apparatus diagrams, system diagrams, and flowcharts that relate to reference signal dropping with regards to high priority channel collisions.

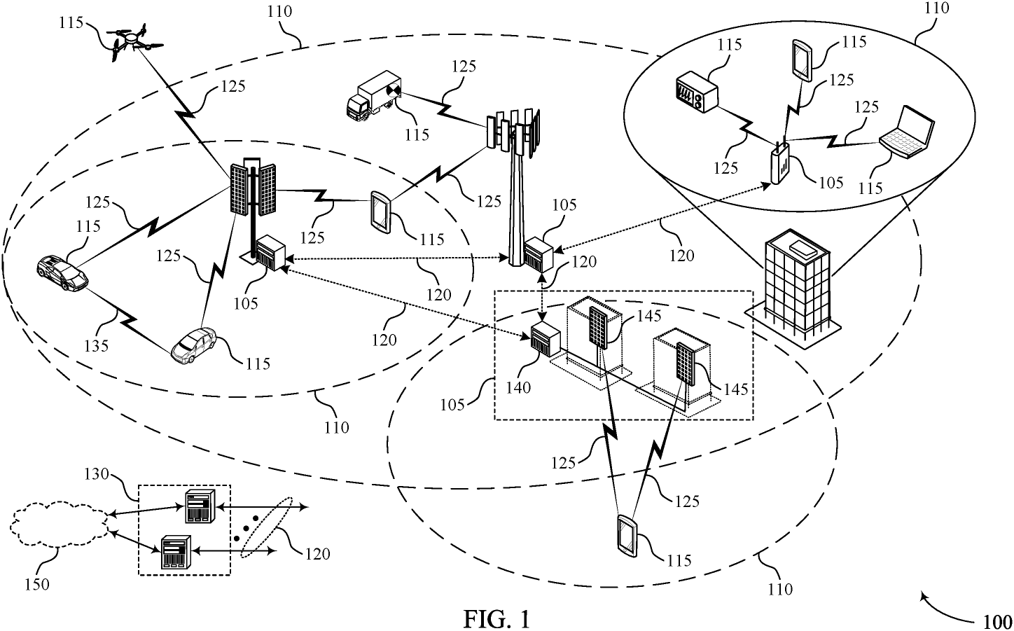

FIG. 1 illustrates an example of a wireless communications system 100 that supports reference signal dropping with regards to high priority channel collisions in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ = 1/(Δƒₘₐₓ · N_{f}) seconds, where Δƒₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The network operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may identify a switching rule pertaining to either carrier switching or antenna switching associated with the UE 115 performing a reference signal transmission scheduled on a second carrier. The UE 115 may receive a grant scheduling a downlink data transmission on a first carrier, the downlink data transmission comprising a priority level satisfying a priority threshold. The UE 115 may determine that the reference signal transmission is scheduled on the second carrier within a time threshold of the downlink data transmission on the first carrier. The UE 115 may monitor for the downlink data transmission instead of performing the reference signal transmission based at least in part on the switching rule and the priority level of the downlink data transmission satisfying the priority threshold.

A UE 115 may receive a grant scheduling an uplink transmission on a first carrier, the uplink transmission comprising a priority level satisfying a priority threshold. The UE 115 may receive a configuration signal indicating a switching rule associated with the UE 115 switching from the first carrier to a second carrier for a reference signal transmission by the UE 115, the switching rule being configurable to either prioritize the reference signal transmission over the uplink transmission or to prioritize the uplink transmission over the reference signal transmission. The UE 115 may determine that the reference signal transmission is scheduled on the second carrier within a time threshold of the uplink transmission on the first carrier. The UE 115 may perform one of the reference signal transmission or the uplink transmission based at least in part on the switching rule.

A base station 105 may transmit a grant scheduling a downlink data transmission on a first carrier, the downlink data transmission comprising a priority level satisfying a priority threshold. The base station 105 may identify, for a UE 115, a switching rule pertaining to either carrier switching or antenna switching associated with the UE 115 performing a reference signal transmission scheduled on a second carrier different from the first carrier, the switching rule identifying a priority relationship between the reference signal transmission and the downlink data transmission based at least in part on the priority level of the downlink data transmission satisfying the priority threshold. The base station 105 may determine that the reference signal transmission is scheduled on the second carrier within a time threshold of the downlink data transmission on the first carrier. The base station 105 may perform the downlink data transmission instead of monitoring for the reference signal transmission based at least in part on the switching rule.

A base station 105 may transmit a grant scheduling an uplink transmission on a first carrier, the uplink transmission comprising a priority level satisfying a priority threshold. The base station 105 may transmit, to a UE 115, a configuration signal indicating a switching rule associated with the UE 115 switching from the first carrier to a second carrier for a reference signal transmission by the UE 115, the switching rule being configurable to either prioritize the reference signal transmission over the uplink transmission or to prioritize the uplink transmission over the reference signal transmission. The base station 105 may determine that the reference signal transmission is scheduled on the second carrier within a time threshold of the uplink transmission on the first carrier. The base station 105 may monitor for one of the reference signal transmission or the uplink transmission based at least in part on the switching rule.

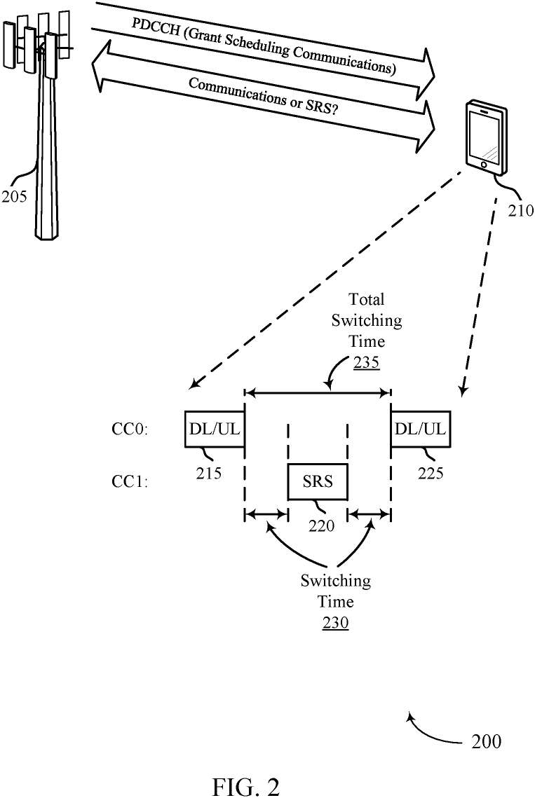

FIG. 2 illustrates an example of a wireless communication system 200 that supports reference signal dropping with regards to high priority channel collisions in accordance with aspects of the present disclosure. In some examples, wireless communication system 200 may implement aspects of wireless communication system 100. Wireless communication system 200 may include base station 205 and/or UE 210, which may be examples of corresponding devices described herein. In some aspects, base station 205 may be a serving base station for UE 210 scheduling communications on a plurality of carriers.

Wireless communication system 200 may support reference signal transmissions (e.g., SRS transmissions 220) by UE 210. For example, base station 205 may configure SRS resources that span one, two, or four adjacent symbols (e.g., within the last six symbols of a slot), with up to four ports per SRS resource. All ports of an SRS resource are sounded in each configured symbol. Generally, an SRS can only be transmitted after the PUSCH in the slot. An SRS resource may include a set of SRS resources transmitted by one UE (e.g., UE 210). An SRS resource may be transmitted aperiodically (e.g., triggered by a downlink control information (DCI)), semi-persistently, and/or periodically. UE 210 may be configured with multiple SRS resources, which may be grouped into an SRS resource set depending on the use case (e.g., AS, codebook-based, non-codebook based, beam management, etc.). The SRS transmission may be on a wideband or subband basis (e.g., the SRS transmission bandwidth may be a multiple of four physical resource blocks (PRBs)).

Conventional wireless communication systems may support SRS carrier switching for UE 210. For example, for an aperiodic SRS triggered in DCI format 2_3 and if UE 210 is configured with higher layer parameter srs-TPC-PDCCH-Group set to ‘typeA’, and given by SRS-CarrierSwitching, without PUSCH/PUCCH transmission, the order of the triggered SRS transmission on the serving cells follow the order of the serving cells in the indicated set of serving cells configured by higher layers, where UE 210 in each serving cell transmits the configured one or two SRS resource set(s) with higher layer parameter usage set to ‘antennaSwitching’ and higher layer parameter resourceType in SRS-ResourceSet set to ‘aperiodic’. For an aperiodic SRS triggered in DCI format 2_3 and if the UE is configured with higher layer parameter srs-TPC-PDCCH-Group set to ‘typeB’ without PUSCH/PUCCH transmission, the order of the triggered SRS transmission on the serving cells follow the order of the serving cells with aperiodic SRS triggered in the DCI, and UE 210 in each serving cell transmits the configured one or two SRS resource set(s) with higher layer parameter usage set to ‘antennaSwitching’ and higher layer parameter resourceType in SRS-ResourceSet set to ‘aperiodic’.

In such conventional wireless communication systems, a UE can be configured with SRS resource(s) on a carrier c1 with slot formats comprised of downlink (DL) and uplink (UL) symbols and not configured for PUSCH/PUCCH transmission. For carrier c1, the UE is configured with higher layer parameter srs-SwitchFromServCellIndex and srs-SwitchFromCarrier the switching from carrier c2 which is configured for PUSCH/PUCCH transmission. During SRS transmission on carrier c1 (including any interruption due to uplink or downlink radio frequency (RF) retuning time as defined by higher layer parameters switchingTimeUL and switchingTimeDL of srs-SwitchingTimeNR), the UE temporarily suspends the uplink transmission on carrier c2. For n-th (n ≥ 1) aperiodic SRS transmission on a cell c, upon detection of a positive SRS request on a grant, the UE shall commence this SRS transmission on the configured symbol and slot provided: it is no earlier than the summation of (1) the maximum time duration between the two durations spanned by N OFDM symbols of the numerology of cell c and the cell carrying the grant respectively, (2) the UL or DL RF retuning time as defined by higher layer parameters switchingTimeUL and switchingTimeDL of srs-SwitchingTimeNR, and (3) it does not collide with any previous SRS transmissions, or interruption due to UL or DL RF retuning time. Otherwise, n-th SRS transmission is dropped, where N is the reported capability as the minimum time interval in unit of symbols, between the DCI triggering an aperiodic SRS transmission.

For a carrier without PUSCH/PUCCH configured, the SRS carrier switching mechanism has also been defined. For example, DCI format 2_3 is used for the transmission of a group of transmit power control (TPC) commands for SRS transmissions by one or more UEs. Along with a TPC command, an SRS request may also be transmitted. The following information may be transmitted by means of the DCI format 2_3 with CRC scrambled by a TPC SRS radio network temporary identifier (TPC-SRS-RNTI): block number 1, block number 2, . . ., block number B, where the starting position of a block is determined by the parameter startingBitOfFormat2-3 or startingBitOfFormat2-3SUL-v1530 provided by higher layers for the UE configured with the block. If the UE is configured with higher layer parameter srs-TPC-PDCCH-Group = typeA for an UL without PUCCH and PUSCH or an UL on which the SRS power control is not tied with PUSCH power control, one block is configured for the UE by higher layers, with the following fields defined for the block: (1) SRS request - 0 or 2 bits. The presence of this field/interpretation of this field is defined by the relevant standards, and (2) TPC command number 1, TPC command number 2, . . ., TPC command number N, where each TPC command applies to a respective UL carrier provided by higher layer parameter cc-IndexInOneCC-Set. If the UE is configured with higher layer parameter srs-TPC-PDCCH-Group = typeB for an UL without PUCCH and PUSCH or an UL on which the SRS power control is not tied with PUSCH power control, one block or more blocks is configured for the UE by higher layers where each block applies to an UL carrier, with the following fields defined for each block: (1) SRS request - 0 or 2 bits (the presence of this field/interpretation of this field is defined in the relevant standards), and (2) TPC command -2 bits.

For a carrier without PUSCH/PUCCH configured, SRS carrier switching mechanism has also been defined. For example, DCI format 2_3 is applicable for uplink carrier(s) of serving cells where a UE is not configured for PUSCH/PUCCH transmission or for uplink carrier(s) of a serving cell where srs-PowerControlAdjustmentStates indicates a separate power control adjustment state between SRS transmissions and PUSCH transmissions. A UE configured by higher layers with parameter carrierSwitching is provided: (1) a TPC-SRS-RNTI for a DCI format 2_3 by tpc-SRS-RNTI, (2) an index of a serving cell where the UE interrupts transmission in order to transmit SRS on one or more other serving cells by srs-SwitchFromServCellIndex, (3) an indication of an uplink carrier where the UE interrupts transmission in order to transmit SRS on one or more other serving cells by srs-SwitchFromCarrier, (4) a DCI format 2_3 field configuration type by typeA or typeB, (5) for typeA, an index for a set of serving cells is provided by cc-SetIndex, indexes of serving cells in the set of serving cells are provided by cc-IndexInOneCC-Set, and a DCI format 2_3 field includes a TPC command for each serving cell from the set of serving cells and can also include a SRS request for SRS transmission on the set of serving cells, (6) for typeB, DCI format 2_3 field includes a TPC command for a serving cell index and can also include a SRS request for SRS transmission on the serving cell, (7) an indication for a serving cell for whether or not a field in DCI format 2_3 includes a SRS request by fieldTypeFormat2 -3 where a value of 0/1 indicates absence/presence of the SRS request - a mapping for a 2 bit SRS request to SRS resource sets as provided in relevant standards, (8) an index for a location in DCI format 2_3 of a first bit for a field for a non-supplementary uplink carrier of the serving cell by startingBitOfFormat2-3, and (9) an index for a location in DCI format 2_3 of a first bit for a field for a supplementary uplink carrier of the serving cell by startingBitOfFormat2-3 SUL-v1530.

The SRS-SwitchingTimeNR generally indicates the interruption time on DL/UL reception within a NR band pair during the RF retuning for switching between a carrier on one band and another (PUSCH-less) carrier on the other band to transmit SRS. This is illustrated in FIG. 2 where UE 210 tuned to carrier 0 (CC0 in this example) for communications 215 (e.g., uplink or downlink communications) is scheduled on carrier one (CC1 in this example) for an SRS transmission 220, followed by UE 210 retuning to CC0 after the SRS transmission 220. The total switching time 235 that it takes for UE 210 to perform the SRS transmission and then be ready to perform communications 225 (e.g., uplink or downlink communications) back on CC0 includes switching time 230 where UE 210 retunes from CC0 to CC1, the time it takes for UE 210 to perform the SRS transmission 230, and the switching time 230 where UE 210 retunes from CC1 back to CC.

The SRS-TxSwitch field defines whether UE 210 supports SRS for DL CSI acquisition as defined in the relevant standards. The capability signaling includes the following parameters: (1) supportedSRS-TxPortSwitch indicates SRS transmit (Tx) port switching pattern supported by the UE (the indicated UE antenna switching capability of ‘xTyR’ corresponds to a UE, capable of SRS transmission on ‘x’ antenna ports over total of ‘y’ antennas, where ‘y’ corresponds to all or subset of UE receive antennas, where 2T4R is two pairs of antennas), (2) txSwitchImpactToRx indicates the entry number of the first-listed band with UL in the band combination that affects this DL, and (3) txSwitchWithAnotherBand indicates the entry number of the first-listed band with UL in the band combination that switches together with this UL. For txSwitchImpactToRx and txSwitchWithAnotherBand, value 1 means first entry, value 2 means second entry and so on. All DL and UL that switch together indicate the same entry number. The UE is restricted not to include fallback band combinations for the purpose of indicating different SRS antenna switching capabilities.

Accordingly, such conventional wireless communication systems may define rules (e.g., switching rules) for a source carrier’s uplink transmission vs SRS carrier switching. One rule may include, for a PUSCH/PUCCH transmission carrying ACK/NACK and/or a positive scheduling request (SR), the UE drops the SRS including switching. Another rule may include, for a PSUCH/PUCCH carrying rank indicator (RI) and/or CSI reference signal (CSI-RS) resource indicator (CRI), the UE drops the SRS including switching. Another rule may include, for a PUSCH carrying aperiodic CSI, the UE drops the periodic/semi-persistent SRS including switching. Another rule may include, for aperiodic SRS including switching, the UE drops PUSCH carrying aperiodic CSI with only CQI/precoding matrix indicator (PMI). Another rule may include, for SRS including switching, the UE drops PUSCH/PUCCH carrying periodic CSI with only CQI/PMI. Another rule may include, for SRS including switching, the UE drops PUSCH without uplink control information (UCI). Another rule may include, for PRACH, the UE drops the SRS including switching. Another rule may include, for SRS including switching, the UE drops non-carrier switching SRS. SRS carrier switching may not be allowed in parallel with other carrier’s uplink transmission(s) due to signaling “no” to simultaneous transmission of SRS on a supplementary uplink (SUL)/non-SUL carrier and PUSCH/PUCCH/SRS/PRACH on the other UL carrier in the same cell.

However, such conventional switching rules are rigid (e.g., a fixed), thus limiting the flexibility of base station 205 and/or UE 210. Moreover, such conventional switching rules do not define UE behavior in the situation where an SRS scheduled on one carrier at least partially overlaps (including switching time 230) with the downlink data transmission (e.g., a PDSCH transmission) on another carrier. For example, the only requirement for SRS is: if the UE is not configured for PUSCH/PUCCH transmission on carrier c1 with slot formats comprised of DL and UL symbols, and if the UE is not capable of simultaneous reception and transmission on carrier c1 and serving cell c2, the UE is not expected to be configured or indicated with SRS resource(s) such that SRS transmission on carrier c1 (including any interruption due to uplink or downlink RF retuning time as defined by higher layer parameters switchingTimeUL and switchingTimeDL of srs-SwitchingTimeNR) would collide with the resource elements (REs) corresponding to the synchronization signal (SS)/physical broadcast channel (PBCH) blocks configured for the UE or the slots belonging to a control resource set indicated by master information block (MIB) or secondary information block one (SIB1) on serving cell c2.

Accordingly, aspects of the described techniques introduce collision rules to be applied for collision (e.g., overlap) of an SRS transmission scheduled on one carrier (e.g., CC1 in this example) that at least partially overlaps with a downlink data transmission on another carrier (e.g., CC0 in this example).

For example, base station 205 may transmit, provide, or otherwise convey, a grant (e.g., a DCI grant carried on PDCCH) scheduling a downlink data transmission on a first carrier (e.g., PDSCH on CC0 in this example) for UE 210. In some examples, the downlink data transmission may have a priority level satisfying a priority threshold. For example, the downlink data transmission may be a URLLC transmission, or any other high-priority PDSCH transmission. The grant may identify resources (e.g., time, frequency, spatial, code, etc.) the UE 210 is to monitor to receive the PDSCH transmission.

Base station 205 and/or UE 210 may select or otherwise identify a switching rule pertaining to either CS or AS associated with the UE performing the reference signal transmission scheduled on a second carrier different from the first carrier (e.g., SRS transmission 220 scheduled on CC1 in this example, which is different from CC0). The switching rule may generally identify or assign a priority relationship between the reference signal transmission (e.g., SRS transmission 220) and the downlink data transmission (e.g., communication 225, which is a downlink data transmission in this example). For example, the priority rule may favor a high priority PDSCH transmission on CC0 over an SRS transmission on CC1.

Accordingly, base station 205 and/or UE 210 may determine that the reference signal transmission on the second carrier (e.g., the SRS transmission 220 scheduled on CC1 in this example) is scheduled within a time threshold of the downlink data transmission on the first carrier (e.g., the communication 225 on CC0 in this example). For example, base station 205 and/or UEs 210 may determine, based on the total switching time 235, that the SRS transmission 220 scheduled on CC1 at least partially overlaps in the time domain with the high priority PDSCH transmission on CC0. In this situation, base station 205 and/or UE 210 may apply the switching rule which favors the high-priority PDSCH transmission over the SRS transmission 220. Accordingly, base station 205 may perform (e.g., transmit) the downlink data transmission and UE 210 may monitor for the downlink data transmission on the resources indicated in the grant. That is, base station 205 may perform the downlink data transmission and UE 210 may monitor for the downlink data transmission, in accordance with the switching rule, instead of performing the reference signal transmission. In this scenario, UE 210 would not retune from CC0 to CC1 to perform the SRS transmission 220. Instead, UE 210 may stay on CC0 in order to monitor for the high-priority PDSCH transmission (e.g., the communication, 225, which is the downlink data transmission in this example).

As discussed above, in some examples the switching rule may pertain to carrier switching (e.g., CS) between the first carrier and the second carrier (e.g., between CC0 and CC1 in this example). In this situation, base station 205 and/or UE 210 may determine the switching time 230 associated with UE 210 switching from the first carrier to the second carrier and/or from the second carrier back to the first carrier (e.g., the switching time 230 to switch from CC0 to CC1 and/or the switching time 230 to switch from CC1 back to CC0). The SRS transmission 220 being within the time threshold may be based on the high-priority PDSCH transmission at least partially overlapping, in the time domain, with the switching time 230 before SRS transmission 220, the SRS transmission 220, and/or the switching time 230 after SRS transmission 220. When there is an overlap, the switching rule may prioritize the high-priority PDSCH transmission over the SRS transmission 220. When there is no overlap, the switching rule may allow the UE to switch from CC0 to CC1, perform the SRS transmission 220, and still retune to CC0 to monitor for the high-priority PDSCH transmission. That is, the time threshold in which the high-priority PDSCH transmission overlaps with the SRS transmission 220 may include the switching time 230 when UE 210 performs CS from CC0 to CC1, the time that UE 210 would use to perform the SRS transmission 220, and/or the switching time 230 when UE 210 performs CS from CC1 back to CC0.

As also discussed above, the switching time of UE 210 may be signaled to base station 205 via an srs-SwitchingTimeNR information element (IE) indicating time parameters switchingTimeUL and switchingTimeDL. The RF retuning time (e.g., the total switching time 235) associated with UE 210 performing SRS transmission 220 may be based on such switching time parameters. For example, the switching time parameter switchingTimeUL and/or switchingTimeDL may correspond to switching time 230, depending on whether UE 210 was performing an uplink or downlink transmission prior to and/or after the SRS transmission 220.

As also discussed above, in some examples a switching rule may pertain to antenna switching (e.g., AS) with the first carrier and second carrier forming at least a portion of, or all of an antenna switching carrier set such that switching from the antennas associated with the second carrier causes switching of antennas associated with the first carrier. In this situation, the reference signal transmission may include a set of SRS transmissions on the second carrier that at least partially overlap with the downlink data transmission. In this situation, the switching rule may be applied on a per-SRS transmission basis. That is, in some scenarios a first subset of the SRS transmissions may be scheduled in non-overlapping resources with respect to the downlink data transmission (e.g., the first one, two, etc., SRS transmissions in the set of SRS transmissions may be non-overlapping with the high-priority PDSCH transmission). In this scenario, a second subset of the SRS transmissions may be scheduled in overlapping resources with respect to the downlink data transmission (e.g., the last one, two, etc., SRS transmissions in the set of SRS transmissions may overlap with the high-priority PDSCH transmission). In this situation, UE 210 may retune to perform the SRS transmissions in the first subset, but may drop the SRS transmissions in the second subset to avoid the overlap with the high-priority PDSCH transmission. Instead, UE 210 may, after performing the SRS transmissions in the first subset, retune to CC0 to monitor for the high priority PDSCH transmission.

In some aspects, the switching rule may be also applied in the situation where the downlink data transmission fails to satisfy the priority threshold (e.g., a non-high priority PDSCH transmission). In this example, base station 205 may transmit, provide, or otherwise convey, a second grant to UE 210 scheduling a second downlink data transmission having a priority level that fails to satisfy the priority threshold. The second downlink data transmission may be scheduled on the first carrier (e.g., CC0 in this example), which may at least partially overlap (e.g., be within the time threshold) with the reference signal transmission scheduled on the second carrier (e.g., CC1 in this example). Application of the switching rule may include UE 210 performing the SRS transmission on the second carrier instead of monitoring for the second downlink data transmission based on the lower priority level.

Additionally or alternatively, aspects of the described techniques provide for a reconfigurable switching rule that can be applied in the situation where certain uplink transmissions are scheduled within the time threshold of an SRS transmission. That is, as discussed above, conventional switching rules are typically fixed and cannot be changed by base station 205 and/or UE 210. Accordingly, aspects of the described techniques provide for a reconfigurable switching rule that can change as needed (e.g., in response to different communication scenarios, different communication requirements, etc.). For example, base station 205 may transmit a grant (e.g., a DCI grant carried on PDCCH) to UE 210 scheduling an uplink transmission having a priority level satisfying the priority threshold (e.g., a high priority PUSCH transmission). Base station 205 may also transmit a configuration signal to UE 210 indicating a switching rule associated with UE 210 switching from the first carrier (e.g., CC0 in this example) to a second carrier (e.g., CC1 in this example) for a reference signal transmission by UE 210 (e.g., for an SRS transmission 220). The switching rule may be configurable to either prioritize the reference signal transmission over the uplink transmission or to prioritize the uplink transmission over the reference signal transmission. For example, in one configuration signal base station 205 may indicate a switching rule that prioritizes the reference signal transmission over the uplink transmission. In a subsequent configuration signal, a base station 205 may indicate the switching rule that prioritizes the uplink transmission over the reference signal transmission. Accordingly, the switching rule may be reconfigured by base station 205 for UE 210.

Base station 205 and/or UE 210 may determine that the reference signal transmission scheduled on the second carrier is within a time threshold of the uplink transmission on the first carrier (e.g., that the SRS transmission 220, including total switching time 235, at least partially overlaps with the high-priority PUSCH transmission in the time domain). In this situation, base station 205 and/or UE 210 may apply the configured switching rule and perform the reference signal transmission or the uplink transmission. For example, when the configured switching rule prioritizes the reference signal transmission, UE 210 may prioritize the reference signal transmission on the second carrier over the uplink transmission on the first carrier. When the configured switching rule prioritizes the uplink transmission, UE 210 may prioritize the uplink transmission on the first carrier over the reference signal transmission on the second carrier.

Accordingly, aspects of the described techniques introduce a higher layer configuration (e.g., RRC signaling, IP-based signaling, etc.) that makes, depending on the configured switching rule, a high priority PUSCH with or without UCI more important than an SRS transmission in a CS scenario. A default rule (e.g., when the switching rule has not been configured) may be that the high priority PUSCH transmission is prioritized over the SRS transmission on the different carrier when there is at least some degree of overlap.

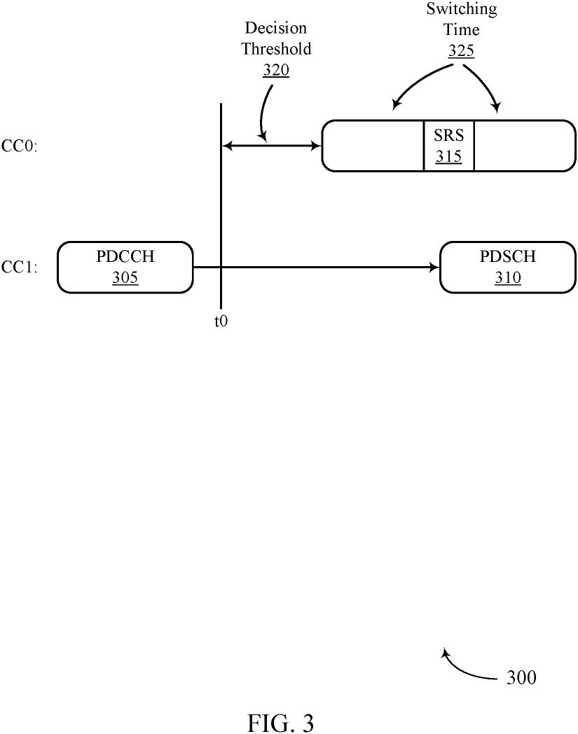

FIG. 3 illustrates an example of a switching configuration 300 that supports reference signal dropping with regards to high priority channel collisions in accordance with aspects of the present disclosure. In some examples, switching configuration 300 may implement aspects of wireless communication systems 100 and/or 200. Aspects of switching configuration 300 may be implemented at or implemented by a base station and/or UE, which may be examples of the corresponding devices described herein. Generally, switching configuration 300 illustrates an example where high-priority PDSCH transmission collides (e.g., at least partially overlaps in the time domain) with a CS SRS switching scenario.

As discussed above, the described techniques provide mechanisms that configure a switching rule to be adopted when a high priority downlink data transmission (e.g., a high priority PDSCH transmission, such as PDSCH 310) overlaps, at least to some degree, with a scheduled reference signal transmission (e.g., SRS transmission 315) on a different carrier. For example, a base station may transmit control information to a UE configuring a switching rule to be applied when the UE, in the CS scenario in this example, is scheduled to perform a reference signal transmission (e.g., SRS transmission 315) that at least partially overlaps with the downlink data transmission (e.g., PDSCH 310). The switching rule may be based on the overlap and the priority level of the downlink data transmission. For example, a high priority PDSCH transmission (e.g., a downlink data transmission having a priority level satisfying a threshold) on CC0 may be favored or otherwise prioritized over the SRS transmission 315 on CC1. The switching rule may be applied in a CS scenario where the high priority PDSCH and the SRS are on separate carriers.

For example, the base station may transmit a grant 305 (e.g., carried in PDCCH) scheduling a downlink data transmission (e.g., PDSCH 310) on a first carrier (e.g., CC1 in this example). The grant 305 may include a DCI grant identifying time, frequency, spatial, code, etc., resources for PDSCH 310. The base station and/or UE may identify a switching rule pertaining to CS or AS (CS in this example) associated with the UE performing the reference signal transmission (e.g., SRS transmission 315) scheduled on the second carrier (e.g., CC0 in this example) different from the first carrier. The switching rule may identify a priority relationship between the reference signal transmission and the downlink data transmission based on the priority level of the downlink data transmission satisfying the priority threshold. For example, the switching rule may favor a high priority PDSCH transmission over an overlapping SRS transmission. The base station and/or UE may determine that the reference signal transmission scheduled on the second carrier is within a time threshold of the downlink data transmission on the first carrier. Applying the switching rule, the UE may monitor for the downlink data transmission instead of performing the reference signal transmission. That is, the UE may stay on CC1 to monitor for the high priority PDSCH transmission (e.g., PDSCH 310) rather than retune to CC0 to perform the SS transmission 315.

As discussed above, in some examples the time threshold may include the reference signal transmission (e.g., SRS transmission 315) as well as any interruption due to uplink or downlink RF retuning time associated with transmission of the reference signal that would collide with REs corresponding to the downlink data transmission. That is, the downlink data transmission being within the time threshold may correspond to any portion of PDSCH 310 that overlaps in the time domain with switching time 325 when the UE retunes from CC1 to CC0, the time that the UE is performing the reference signal transmission (e.g., SRS transmission 315), and/or the switching time 325 when UE retunes from CC0 back to CC1 and is ready to monitor for the data transmission. In the non-limiting example illustrated in FIG. 3, PDSCH 310 at least partially overlaps with the time domain when the UE is performing the reference signal transmission (e.g., SRS transmission 315) and the switching time 325 when UE retunes from CC0 back to CC1 and is ready to monitor for the data transmission. Accordingly, application of the switching rule in this scenario may result in the UE monitoring for PDSCH 310 instead of performing the SRS 315 transmission.

In some aspects, application of the switching rule may be based on a decision threshold 320. That is, the UE may determine that the grant (e.g., PDSCH 305) is received in advance of the UE performing the reference signal transmission scheduled on the second carrier by at least a switching decision threshold amount of time (e.g., decision threshold 320). Accordingly, the UE may receive a grant (e.g., PDCCH 305) and then may identify and apply the switching rule prior to time t0. That is, the UE may receive a grant, determine that PDSCH 310 has a priority level satisfying the threshold, and that the SRS transmission 315 including switching time 325 before and after) overlaps with PDSCH 310. If the UE can make this determination prior to t0, then the UE may apply the switching rule. However, application of the switching rule in some scenarios may include the UE determining that it is unable to make this determination prior to t0 (e.g., the time difference between the grant and the PDSCH 310 transmission is too short. In this situation, the UE may revert to a default rule that prioritizes PDSCH 310 based on the corresponding priority level or prioritizes SRS transmission 315.

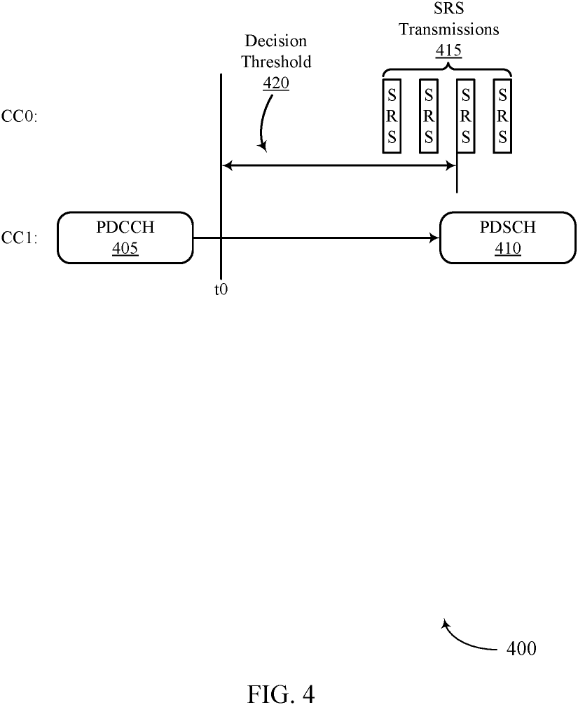

FIG. 4 illustrates an example of a switching configuration 400 that supports reference signal dropping with regards to high priority channel collisions in accordance with aspects of the present disclosure. In some examples, switching configuration 400 may implement aspects of wireless communication systems 100 and/or 200. Aspects of switching configuration 400 may be implemented at or implemented by a base station and/or UE, which may be examples of the corresponding devices described herein. Generally, switching configuration 400 illustrates an example where high-priority PDSCH transmission collides (e.g., at least partially overlaps in the time domain) with an AS SRS switching scenario.

As discussed above, the described techniques provide mechanisms that configure a switching rule to be adopted when a high priority downlink data transmission (e.g., a high priority PDSCH transmission, such as PDSCH 410) overlaps, at least to some degree, with a scheduled reference signal transmission (e.g., SRS transmissions 415, which may define a set of SRS transmissions and with four SRS transmissions being shown by way of example only) on a different carrier. For example, a base station may transmit control information to a UE configuring a switching rule to be applied when the UE, in the SS scenario in this example, is scheduled to perform a reference signal transmission (e.g., SRS transmissions 415) that at least partially overlaps with the downlink data transmission (e.g., PDSCH 410). The switching rule may be based on the overlap and the priority level of the downlink data transmission. For example, a high priority PDSCH transmission (e.g., a downlink data transmission having a priority level satisfying a threshold) on CC0 may be favored or otherwise prioritized over the SRS transmissions 415 on CC1. The switching rule may be applied in a AS scenario where the high priority PDSCH and the SRS are on separate carriers.

For example, the base station may transmit a grant 405 (e.g., carried in PDCCH) scheduling a downlink data transmission (e.g., PDSCH 310) on a first carrier (e.g., CC1 in this example). The grant 405 may include a DCI grant identifying time, frequency, spatial, code, etc., resources for PDSCH 410. The base station and/or UE may identify a switching rule pertaining to CS or AS (AS in this example) associated with the UE performing the reference signal transmission (e.g., SRS transmissions 415) scheduled on the second carrier (e.g., CC0 in this example) different from the first carrier. The switching rule may identify a priority relationship between the reference signal transmission and the downlink data transmission based on the priority level of the downlink data transmission satisfying the priority threshold. For example, the switching rule may favor a high priority PDSCH transmission over overlapping SRS transmission(s). The base station and/or UE may determine that the reference signal transmission scheduled on the second carrier is within a time threshold of the downlink data transmission on the first carrier. Applying the switching rule, the UE may monitor for the downlink data transmission instead of performing the reference signal transmission. That is, the UE may stay on CC1 to monitor for the high priority PDSCH transmission (e.g., PDSCH 410) rather than retune to CC0 to perform the SS transmissions 415.

As discussed above, in some examples the time threshold may include the reference signal transmission (e.g., SRS transmissions 415) as well as any interruption due to uplink or downlink RF retuning time associated with transmission of the reference signal that would collide with REs corresponding to the downlink data transmission. That is, the downlink data transmission being within the time threshold may correspond to any portion of PDSCH 410 that overlaps in the time domain with the switching time when the UE retunes from CC1 to CC0, the time that the UE is performing the reference signal transmission (e.g., SRS transmissions 415), and/or the switching time when the UE retunes from CC0 back to CC1 and is ready to monitor for the data transmission. In the non-limiting example illustrated in FIG. 4, PDSCH 410 at least partially overlaps with the time domain when the UE is performing the reference signal transmission (e.g., SRS transmissions 415) and the switching time when the UE retunes from CC0 back to CC1 and is ready to monitor for the data transmission. Accordingly, application of the switching rule in this scenario may result in the UE monitoring for PDSCH 410 instead of performing the SRS transmissions 415.

In some aspects, application of the switching rule may be based on a decision threshold 420. That is, the UE may determine that the grant (e.g., PDSCH 405) is received in advance of the UE performing the reference signal transmission scheduled on the second carrier by at least a switching decision threshold amount of time (e.g., decision threshold 420). Accordingly, the UE may receive a grant (e.g., PDCCH 405) and then may identify and apply the switching rule prior to time t0. That is, the UE may receive a grant, determine that PDSCH 410 has a priority level satisfying the threshold, and that the SRS transmissions 415 including the switching times before and after) overlaps with PDSCH 410. If the UE can make this determination prior to t0, then the UE may apply the switching rule. However, application of the switching rule in some scenarios may include the UE determining that it is unable to make this determination prior to t0 (e.g., the time difference between the grant and the PDSCH 410 transmission is too short). In this situation, the UE may revert to a default rule that prioritizes PDSCH 410 based on the corresponding priority level or prioritizes SRS transmission 415.

As also discussed above, in some examples the UE may receive an indication that the switching rule pertains to AS. In this scenario and as illustrated in FIG. 4, the first carrier and second carrier may form an antenna switching carrier set such that the switching of antennas associated with the second carrier causes switching of antennas associated with the first carrier. The UE may determine that the reference signal transmission includes a set of reference signal transmissions on the second carrier (e.g., SRS transmissions 415, with four SRS transmissions being shown in the set of reference signal transmissions by way of example only). In this situation, the UE may determine that a one or more, but not all, of the SRS transmissions overlap with the high priority PDSCH. For example, the UE may determine that at least one SRS transmission in the set of reference signal transmissions (e.g., SRS transmissions 415) on the second carrier at least partially overlaps with the downlink data transmission on the first carrier. This may indicate that the reference signal transmission partially overlaps with the downlink data transmission, which may trigger the switching rule prioritizing the downlink data transmission over the reference signal transmission. In some examples, the UE may identify that a first subset of reference signal transmissions (e.g., the first two SRS transmissions in SRS transmissions 415 in this example) are scheduled on non-overlapping resources of the downlink data transmission and that a second subset of reference signal transmissions (e.g., the last two SRS transmissions in SRS transmissions 415 in this example) are scheduled on overlapping resources of the downlink data transmission. Accordingly, application of the switching rule in this example may include the UE performing the SRS transmissions in the first subset, but not performing the SRS transmissions in the second subset.

Accordingly, the base station may indicate which carriers (e.g., CCs) in different bands “switch together” with SRS antenna switching. Aspects of the described techniques cancel, at least to some degree, the SRS transmission(s) if the PDSCH with a high priority overlaps with the SRS transmission (including switching times, a timing advance, etc.) and the PDSCH carrier and SRS are for two carriers that belong in bands that switch together. Cancellation (e.g., dropping) of the SRS transmissions may be on a resource level (e.g., at the RE level), resource set level, and/or at the symbol level.

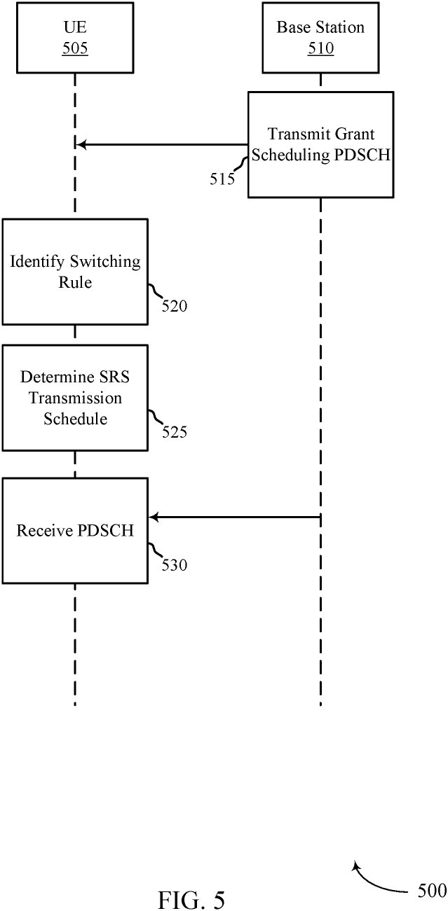

FIG. 5 illustrates an example of a process 500 that supports reference signal dropping with regards to high priority channel collisions in accordance with aspects of the present disclosure. In some examples, process 500 may implement aspects of wireless communication systems 100 and/or 200 and/or switching configurations 300 and/or 400. Aspects of process 500 may be implemented at or implemented by UE 505 and/or base station 510, which may be examples of corresponding devices described herein.

At 515, base station 510 may transmit (and UE 505 may receive) a grant scheduling a downlink data transmission on a first carrier. In some aspects, the downlink data transmission may have a priority level satisfying a priority threshold. The grant may correspond to a DCI grant carried on PDCCH. The grant may identify resources that UE 505 would monitor to receive the downlink data transmission.

At 520, UE 505 may identify a switching rule pertaining to either carrier switching or antenna switching associated with UE 505 performing a reference signal transmission scheduled on a second carrier different from the first carrier (e.g., SRS transmissions on a different carrier). In some examples, the switching rule may identify a priority relationship between the reference signal transmission and the downlink data transmission based on the priority level of the downlink data transmission satisfying the priority threshold.

In some aspects, this may include UE 505 receiving an indication from base station 510 that the switching rule pertains to carrier switching between the first carrier and the second carrier for UE 505 to perform the reference signal transmission on the second carrier. UE 505 may identify a switching time associated with UE 505 switching from the first carrier to the second carrier and/or from the second carrier back to the first carrier. Determining that the reference signal transmission is scheduled within the time threshold may be based on the switching time. In some aspects, UE 505 may determine that at least one of the switching times associated with UE 505 switching from the first carrier to the second carrier, the reference signal transmission, and/or a switching time associated with UE 505 switching from the second carrier to the first carrier after the reference signal transmission is scheduled at least partially overlaps the downlink data transmission. Determining that the reference signal transmission is scheduled within the time threshold may be based on the switching time at least partially overlapping with the downlink data transmission. In some aspects, UE 505 may identify the time threshold as including the reference signal transmission and any interruption due to uplink or downlink RF retuning time associated with transmission of the reference signal that would collide with resource elements corresponding to the downlink data transmission. For example, UE 505 may receive an indication of switching time parameters switchingTimeUL and switchingTimeDL via an srs-SwitchingTimeNR IE. The uplink or downlink RF retuning time associated with transmission of the reference signal may be based on the switching time parameters.

In some aspects, UE 505 may receive an indication that the switching rule pertains to antenna switching. In this example, the first carrier and the second carrier may form an antenna switching carrier set such that switching of antennas associated with the second carrier causes switching of antennas associated with the first carrier. UE 505 may determine that the reference signal transmission comprises a set of reference signal transmissions on the second carrier. Accordingly, UE 505 may determine that at least one of the reference signal transmissions on the second carrier at least partially overlaps with the downlink data transmission. The determination that the reference signal is scheduled within the time threshold may be based on the at least one reference signal transmission overlapping with the downlink data transmission. In some aspects, UE 505 may identify a first subset of reference signal transmissions in the set of reference signal transmissions that are scheduled in non-overlapping resources of the downlink data transmission. UE 505 may identify a second subset of reference signal transmissions in the set of reference signal transmissions that are scheduled in at least partially overlapping resources of the downlink data transmission. Application of the switching rule may include UE 505 performing the first subset of reference signal transmissions, but not performing the second subset of reference signal transmissions.

At 525, UE 505 may determine that the reference signal transmission is scheduled on the second carrier within a time threshold of the downlink data transmission on the first carrier. For example, UE 505 may determine that the grant is received in advance of the UE performing the reference signal transmission scheduled on the second carrier by at least a switching decision threshold amount of time. Accordingly and at 530, UE 505 may apply the switching rule based on the priority level and monitor for the downlink data transmission from base station 510 instead of performing the reference signal transmission.

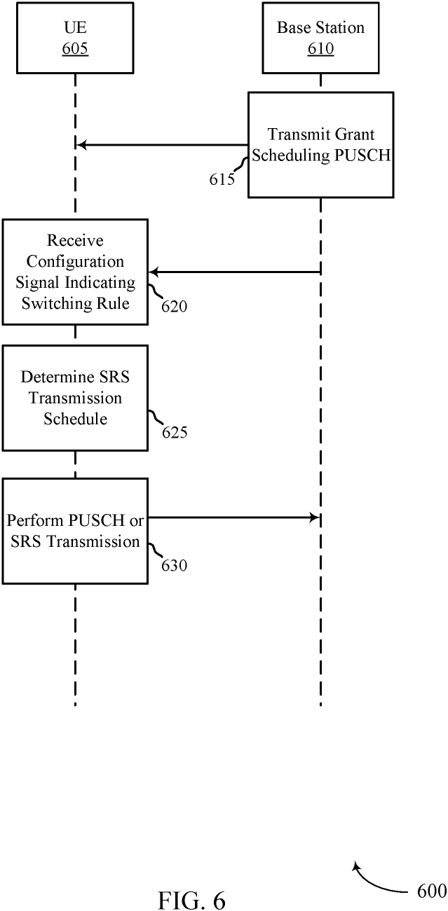

FIG. 6 illustrates an example of a process 600 that supports reference signal dropping with regards to high priority channel collisions in accordance with aspects of the present disclosure. In some examples, process 600 may implement aspects of wireless communication systems 100 and/or 200, switching configurations 300 and/or 400, and/or process 500. Aspects of process 600 may be implemented by or implemented at UE 605 and/or base station 610, which may be examples of corresponding devices described herein.

At 615, base station 610 may transmit (and UE 605 may receive) a grant scheduling an uplink transmission on a first carrier. The uplink transmission may have a corresponding priority level satisfying a priority threshold. For example, the uplink transmission may correspond to a high priority PUSCH transmission.

At 620, base station 610 may transmit (and UE 605 may receive) a configuration signal indicating a switching rule associated with UE 605 switching from the first carrier to a second carrier for a reference signal transmission by UE 605. In some aspects, the switching rule may be configurable to either prioritize a reference signal transmission over the uplink transmission or to prioritize the uplink transmission over the reference signal transmission.

At 615, UE 605 may determine that the reference signal transmission scheduled on the second carrier is within a time threshold of the uplink transmission on the first carrier. Accordingly and at 630, UE 605 may either perform the reference signal transmission or the uplink transmission based on the switching rule. For example, when the switching rule prioritizes the reference signal transmission over the uplink transmission, UE 605 may perform the reference signal transmission on the second carrier instead of performing the uplink transmission on the first carrier. When the switching rule prioritizes the uplink transmission over the reference signal transmission, UE 605 may perform the uplink transmission on the first carrier instead of performing the reference signal transmission on the second carrier. Accordingly, the reconfigurable switching rule may be leveraged, as needed, to adapt to changing communication needs.

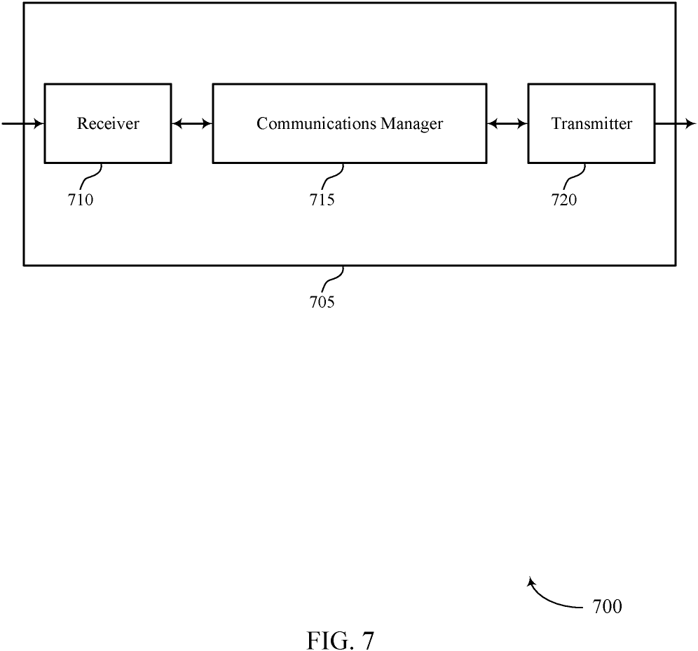

FIG. 7 shows a block diagram 700 of a device 705 that supports reference signal dropping with regards to high priority channel collisions in accordance with aspects of the present disclosure. The device 705 may be an example of aspects of a UE 115 as described herein. The device 705 may include a receiver 710, a communications manager 715, and a transmitter 720. The device 705 may also include a processor. Each of these components may be in communication with one another (e.g., via one or more buses).

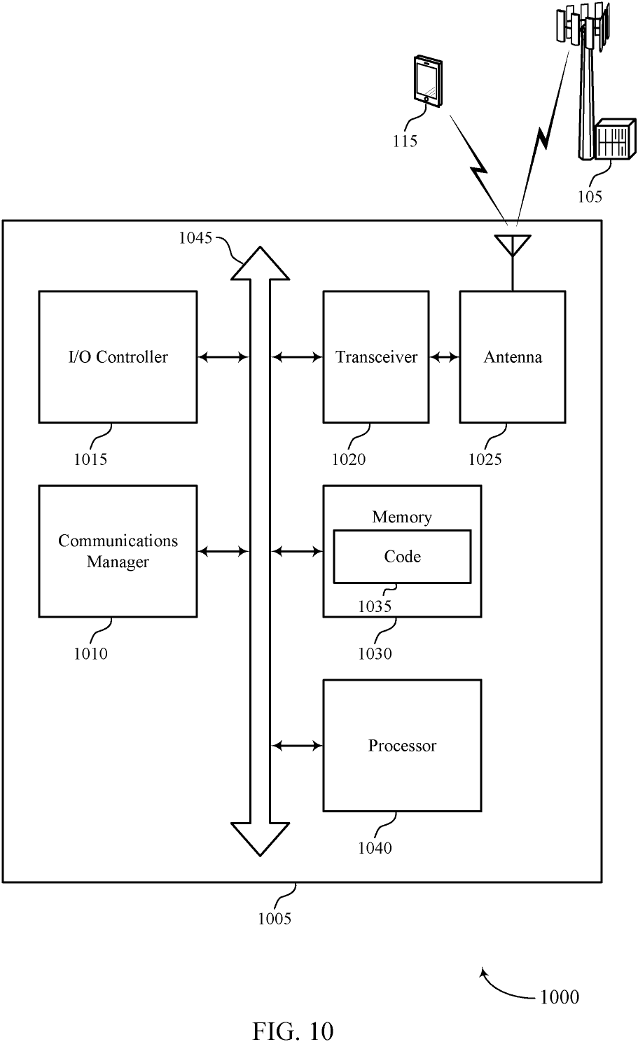

The receiver 710 may receive information such as packets, user data, or control information associated with various information channels (e.g., control channels, data channels, and information related to reference signal dropping with regards to high priority channel collisions, etc.). Information may be passed on to other components of the device 705. The receiver 710 may be an example of aspects of the transceiver 1020 described with reference to FIG. 10. The receiver 710 may utilize a single antenna or a set of antennas.

The communications manager 715 may identify a switching rule pertaining to either carrier switching or antenna switching associated with the UE performing a reference signal transmission scheduled on a second carrier, receive a grant scheduling a downlink data transmission on a first carrier, the downlink data transmission including a priority level satisfying a priority threshold, determine that the reference signal transmission is scheduled on the second carrier within a time threshold of the downlink data transmission on the first carrier, and receive the downlink data transmission instead of performing the reference signal transmission based on the switching rule and the priority level of the downlink data transmission satisfying the priority threshold.

The communications manager 715 may also receive a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission, receive a grant scheduling an uplink transmission on the first carrier, the uplink transmission including the priority level satisfying the priority threshold, determine that the reference signal transmission is scheduled on the second carrier within a time threshold of the uplink transmission on the first carrier, and perform one of the reference signal transmission or the uplink transmission based on the switching rule and the priority level of the uplink transmission satisfying the priority threshold. The communications manager 715 may be an example of aspects of the communications manager 1010 described herein.

The communications manager 715, or its sub-components, may be implemented in hardware, code (e.g., software or firmware) executed by a processor, or any combination thereof. If implemented in code executed by a processor, the functions of the communications manager 715, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 715, or its sub-components, may be physically located at various positions, including being distributed such that portions of functions are implemented at different physical locations by one or more physical components. In some examples, the communications manager 715, or its sub-components, may be a separate and distinct component in accordance with various aspects of the present disclosure. In some examples, the communications manager 715, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 720 may transmit signals generated by other components of the device 705. In some examples, the transmitter 720 may be collocated with a receiver 710 in a transceiver module. For example, the transmitter 720 may be an example of aspects of the transceiver 1020 described with reference to FIG. 10. The transmitter 720 may utilize a single antenna or a set of antennas.

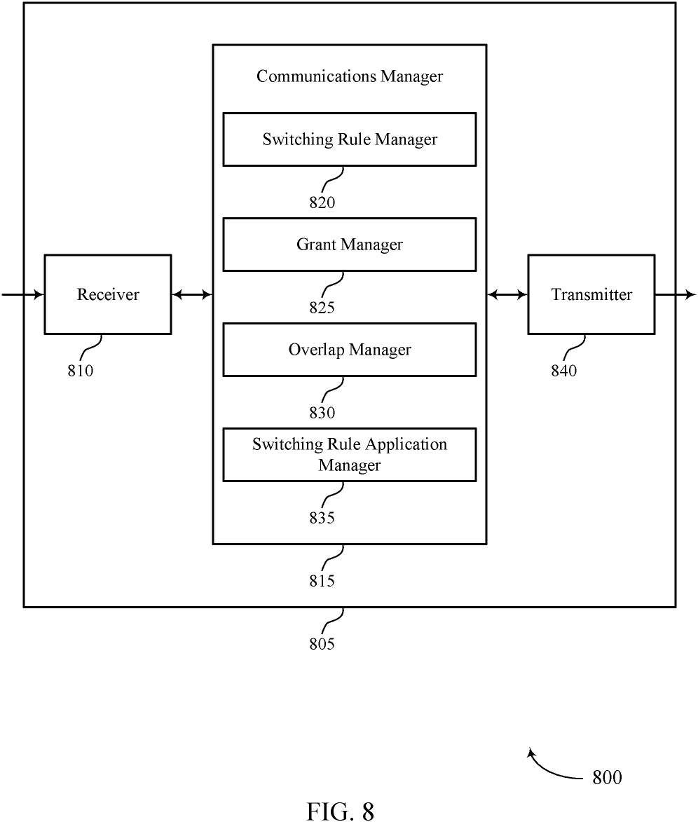

FIG. 8 shows a block diagram 800 of a device 805 that supports reference signal dropping with regards to high priority channel collisions in accordance with aspects of the present disclosure. The device 805 may be an example of aspects of a device 705, or a UE 115 as described herein. The device 805 may include a receiver 810, a communications manager 815, and a transmitter 840. The device 805 may also include a processor. Each of these components may be in communication with one another (e.g., via one or more buses).

The receiver 810 may receive information such as packets, user data, or control information associated with various information channels (e.g., control channels, data channels, and information related to reference signal dropping with regards to high priority channel collisions, etc.). Information may be passed on to other components of the device 805. The receiver 810 may be an example of aspects of the transceiver 1020 described with reference to FIG. 10. The receiver 810 may utilize a single antenna or a set of antennas.

The communications manager 815 may be an example of aspects of the communications manager 715 as described herein. The communications manager 815 may include a switching rule manager 820, a grant manager 825, an overlap manager 830, and a switching rule application manager 835. The communications manager 815 may be an example of aspects of the communications manager 1010 described herein.

The switching rule manager 820 may identify a switching rule pertaining to either carrier switching or antenna switching associated with the UE performing a reference signal transmission scheduled on a second carrier.

The grant manager 825 may receive a grant scheduling a downlink data transmission on a first carrier, the downlink data transmission including a priority level satisfying a priority threshold.

The overlap manager 830 may determine that the reference signal transmission is scheduled on the second carrier within a time threshold of the downlink data transmission on the first carrier.

The switching rule application manager 835 may receive the downlink data transmission instead of performing the reference signal transmission based on the switching rule and the priority level of the downlink data transmission satisfying the priority threshold.

The switching rule manager 820 may receive a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission.

The grant manager 825 may receive a grant scheduling an uplink transmission on the first carrier, the uplink transmission including the priority level satisfying the priority threshold.

The overlap manager 830 may determine that the reference signal transmission is scheduled on the second carrier within a time threshold of the uplink transmission on the first carrier.

The switching rule application manager 835 may perform one of the reference signal transmission or the uplink transmission based on the switching rule and the priority level of the uplink transmission satisfying the priority threshold.

The transmitter 840 may transmit signals generated by other components of the device 805. In some examples, the transmitter 840 may be collocated with a receiver 810 in a transceiver module. For example, the transmitter 840 may be an example of aspects of the transceiver 1020 described with reference to FIG. 10. The transmitter 840 may utilize a single antenna or a set of antennas.

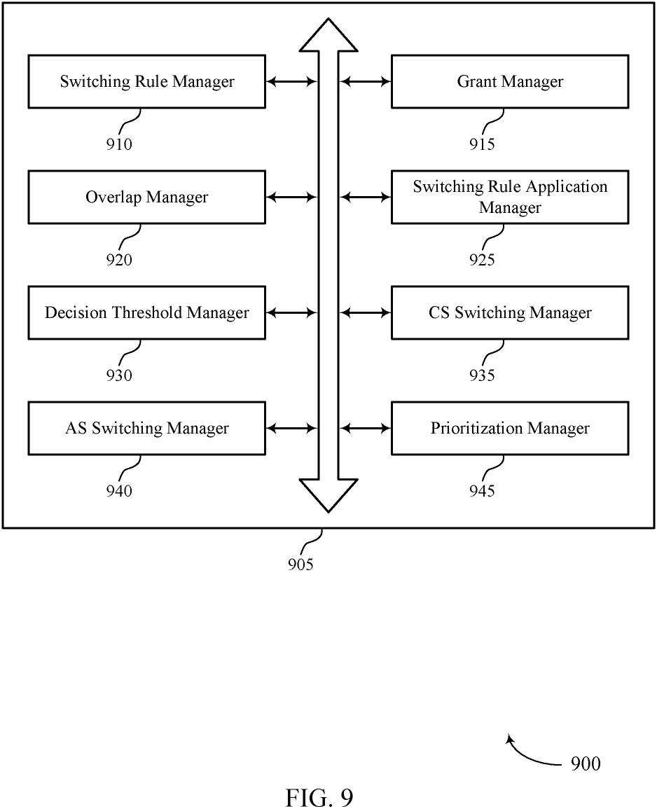

FIG. 9 shows a block diagram 900 of a communications manager 905 that supports reference signal dropping with regards to high priority channel collisions in accordance with aspects of the present disclosure. The communications manager 905 may be an example of aspects of a communications manager 715, a communications manager 815, or a communications manager 1010 described herein. The communications manager 905 may include a switching rule manager 910, a grant manager 915, an overlap manager 920, a switching rule application manager 925, a decision threshold manager 930, a CS switching manager 935, an AS switching manager 940, and a prioritization manager 945. Each of these modules may communicate, directly or indirectly, with one another (e.g., via one or more buses).

The switching rule manager 910 may identify a switching rule pertaining to either carrier switching or antenna switching associated with the UE performing a reference signal transmission scheduled on a second carrier. In some examples, the switching rule manager 910 may receive a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission. In some cases, the switching rule includes a carrier switching rule, an antenna switching rule, or both.

The grant manager 915 may receive a grant scheduling a downlink data transmission on a first carrier, the downlink data transmission including a priority level satisfying a priority threshold. In some examples, the grant manager 915 may receive a grant scheduling an uplink transmission on the first carrier, the uplink transmission including the priority level satisfying the priority threshold.

The overlap manager 920 may determine that the reference signal transmission is scheduled on the second carrier within a time threshold of the downlink data transmission on the first carrier. In some examples, the overlap manager 920 may determine that the reference signal transmission is scheduled on the second carrier within a time threshold of the uplink transmission on the first carrier. In some cases, the reference signal transmission includes an SRS transmission.

The switching rule application manager 925 may receive the downlink data transmission instead of performing the reference signal transmission based on the switching rule and the priority level of the downlink data transmission satisfying the priority threshold. In some examples, the switching rule application manager 925 may perform one of the reference signal transmission or the uplink transmission based on the switching rule and the priority level of the uplink transmission satisfying the priority threshold. In some examples, the switching rule application manager 925 may receive a second grant scheduling a second downlink data transmission on the first carrier, the second downlink data transmission including a second priority level that fails to satisfy the priority threshold.

In some examples, the switching rule application manager 925 may determine that a second reference signal transmission is scheduled on the second carrier within the time threshold of the second downlink data transmission. In some examples, the switching rule application manager 925 may perform the second reference signal transmission instead of performing the second downlink data transmission based on the switching rule and the second priority level failing to satisfy the priority threshold.

The decision threshold manager 930 may determine that the grant is received in advance of the UE performing the reference signal transmission scheduled on the second carrier by at least a switching decision threshold amount of time, where receiving the downlink data transmission instead of performing the reference signal transmission is based on the grant being received before the UE is scheduled to perform the reference signal transmission by at least the switching decision threshold.

The CS switching manager 935 may receive an indication that the switching rule pertains to carrier switching between the first carrier and the second carrier for UE to perform the reference signal transmission on the second carrier. In some examples, the CS switching manager 935 may identify a switching time associated with the UE switching from the first carrier to the second carrier, from the second carrier back to the first carrier, or both, where determining that the reference signal transmission is scheduled within the time threshold is based on the switching time.

In some examples, the CS switching manager 935 may determine that at least one of a switching time associated with the UE switching from the first carrier to the second carrier, the reference signal transmission, or a switching time associated with the UE switching from the second carrier to the first carrier after the reference signal transmission is scheduled at least partially overlaps the downlink data transmission, where determining that the reference signal transmission is scheduled within the time threshold is based on the switching time at least partially overlapping with the downlink data transmission.

The AS switching manager 940 may receive an indication that the switching rule pertains to antenna switching, where the first carrier and the second carrier include an antenna switching carrier set such that switching of antennas associated with the second carrier causes switching of antennas associated with the first carrier. In some examples, determining that the reference signal transmission includes a set of reference signal transmissions on the second carrier.

In some examples, the AS switching manager 940 may determine that at least one of the set of reference signal transmissions on the second carrier at least partially overlaps the downlink data transmission, where determining that the reference signal transmission is scheduled within the time threshold is based on the at least one of the set of reference signal transmissions at least partially overlapping with the downlink data transmission. In some examples, determining that the reference signal transmission includes a set of reference signal transmissions on the second carrier. In some examples, the AS switching manager 940 may identify a first subset of reference signal transmissions in the set of reference signal transmissions that are scheduled in non-overlapping resources of the downlink data transmission. In some examples, identifying a second subset of reference signal transmissions in the set of reference signal transmissions that are scheduled in at least partially overlapping resources of the downlink data transmission, where receiving the downlink data transmission instead of performing the reference signal transmission includes performing the first subset of reference signal transmissions but refraining from performing the second subset of reference signal transmissions.

The prioritization manager 945 may prioritize, based on the switching rule and the priority level of the uplink transmission satisfying the priority threshold, the reference signal transmission on the second carrier over the uplink transmission on the first carrier. In some examples, the prioritization manager 945 may prioritize, based on the switching rule and the priority level of the uplink transmission satisfying the priority threshold, the uplink transmission on the first carrier over the reference signal transmission on the second carrier.

FIG. 10 shows a diagram of a system 1000 including a device 1005 that supports reference signal dropping with regards to high priority channel collisions in accordance with aspects of the present disclosure. The device 1005 may be an example of or include the components of device 705, device 805, or a UE 115 as described herein. The device 1005 may include components for bi-directional voice and data communications including components for transmitting and receiving communications, including a communications manager 1010, an I/O controller 1015, a transceiver 1020, an antenna 1025, memory 1030, and a processor 1040. These components may be in electronic communication via one or more buses (e.g., bus 1045).

The communications manager 1010 may identify a switching rule pertaining to either carrier switching or antenna switching associated with the UE performing a reference signal transmission scheduled on a second carrier, receive a grant scheduling a downlink data transmission on a first carrier, the downlink data transmission including a priority level satisfying a priority threshold, determine that the reference signal transmission is scheduled on the second carrier within a time threshold of the downlink data transmission on the first carrier, and receive the downlink data transmission instead of performing the reference signal transmission based on the switching rule and the priority level of the downlink data transmission satisfying the priority threshold.

The communications manager 1010 may also receive a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission, receive a grant scheduling an uplink transmission on the first carrier, the uplink transmission including the priority level satisfying the priority threshold, determine that the reference signal transmission is scheduled on the second carrier within a time threshold of the uplink transmission on the first carrier, and perform one of the reference signal transmission or the uplink transmission based on the switching rule and the priority level of the uplink transmission satisfying the priority threshold.

The I/O controller 1015 may manage input and output signals for the device 1005. The I/O controller 1015 may also manage peripherals not integrated into the device 1005. In some cases, the I/O controller 1015 may represent a physical connection or port to an external peripheral. In some cases, the I/O controller 1015 may utilize an operating system such as iOS®, ANDROID®, MS-DOS®, MS-WINDOWS®, OS/2®, UNIX®, LINUX®, or another known operating system. In other cases, the I/O controller 1015 may represent or interact with a modem, a keyboard, a mouse, a touchscreen, or a similar device. In some cases, the I/O controller 1015 may be implemented as part of a processor. In some cases, a user may interact with the device 1005 via the I/O controller 1015 or via hardware components controlled by the I/O controller 1015.

The transceiver 1020 may communicate bi-directionally, via one or more antennas, wired, or wireless links as described above. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some cases, the wireless device may include a single antenna 1025. However, in some cases the device may have more than one antenna 1025, which may be capable of concurrently transmitting or receiving multiple wireless transmissions.

The memory 1030 may include random access memory (RAM) and read-only memory (ROM). The memory 1030 may store computer-readable, computer-executable code 1035 including instructions that, when executed, cause the processor to perform various functions described herein. In some cases, the memory 1030 may contain, among other things, a basic input/output system (BIOS) which may control basic hardware or software operation such as the interaction with peripheral components or devices.

The processor 1040 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting reference signal dropping with regards to high priority channel collisions).

The code 1035 may include instructions to implement aspects of the present disclosure, including instructions to support wireless communications. The code 1035 may be stored in a non-transitory computer-readable medium such as system memory or other type of memory. In some cases, the code 1035 may not be directly executable by the processor 1040 but may cause a computer (e.g., when compiled and executed) to perform functions described herein.

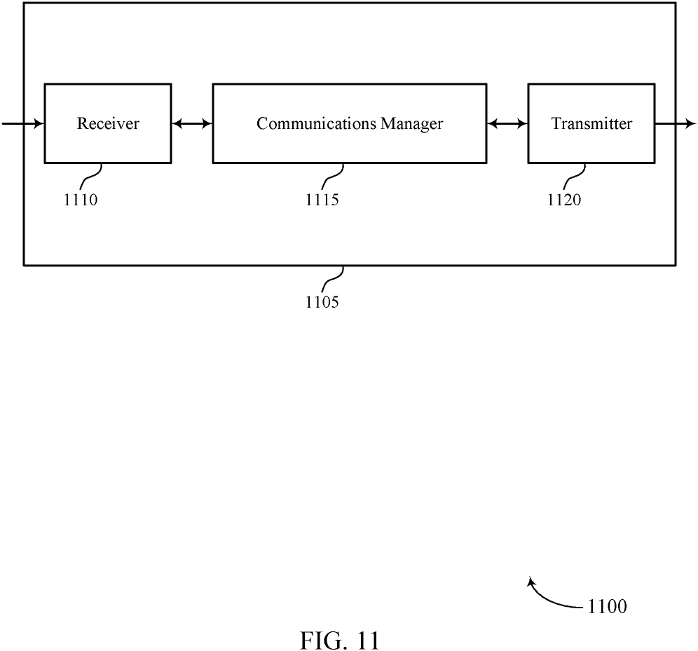

FIG. 11 shows a block diagram 1100 of a device 1105 that supports reference signal dropping with regards to high priority channel collisions in accordance with aspects of the present disclosure. The device 1105 may be an example of aspects of a base station 105 as described herein. The device 1105 may include a receiver 1110, a communications manager 1115, and a transmitter 1120. The device 1105 may also include a processor. Each of these components may be in communication with one another (e.g., via one or more buses).

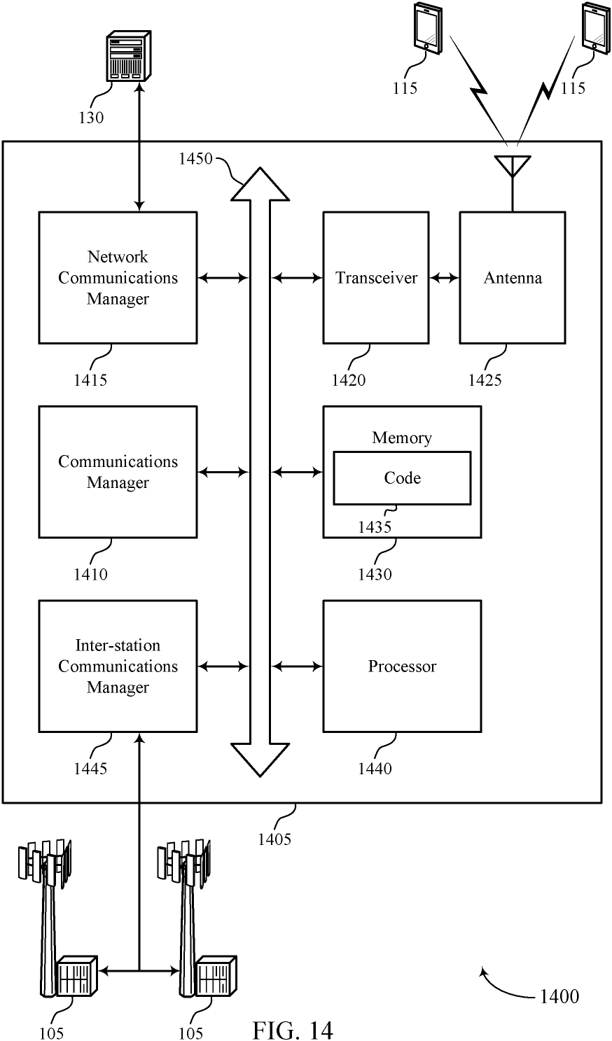

The receiver 1110 may receive information such as packets, user data, or control information associated with various information channels (e.g., control channels, data channels, and information related to reference signal dropping with regards to high priority channel collisions, etc.). Information may be passed on to other components of the device 1105. The receiver 1110 may be an example of aspects of the transceiver 1420 described with reference to FIG. 14. The receiver 1110 may utilize a single antenna or a set of antennas.

The communications manager 1115 may identify, for a UE, a switching rule pertaining to either carrier switching or antenna switching associated with the UE performing a reference signal transmission scheduled on a second carrier, transmit a grant scheduling a downlink data transmission on a first carrier, the downlink data transmission including a priority level satisfying a priority threshold, determine that the reference signal transmission is scheduled on the second carrier within a time threshold of the downlink data transmission on the first carrier, and perform the downlink data transmission instead of monitoring for the reference signal transmission based on the switching rule and the priority level of the downlink data transmission satisfying the priority threshold.

The communications manager 1115 may also transmit, to a UE, a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission, transmit a grant scheduling an uplink transmission on the first carrier, the uplink transmission including the priority level satisfying the priority threshold, determine that the reference signal transmission is scheduled on the second carrier within a time threshold of the uplink transmission on the first carrier, and monitor for one of the reference signal transmission or the uplink transmission based on the switching rule and the priority level of the uplink transmission satisfying the priority threshold. The communications manager 1115 may be an example of aspects of the communications manager 1410 described herein.

The communications manager 1115, or its sub-components, may be implemented in hardware, code (e.g., software or firmware) executed by a processor, or any combination thereof. If implemented in code executed by a processor, the functions of the communications manager 1115, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 1115, or its sub-components, may be physically located at various positions, including being distributed such that portions of functions are implemented at different physical locations by one or more physical components. In some examples, the communications manager 1115, or its sub-components, may be a separate and distinct component in accordance with various aspects of the present disclosure. In some examples, the communications manager 1115, or its sub-components, may be combined with one or more other hardware components, including but not limited to an I/O component, a transceiver, a network server, another computing device, one or more other components described in the present disclosure, or a combination thereof in accordance with various aspects of the present disclosure.

The transmitter 1120 may transmit signals generated by other components of the device 1105. In some examples, the transmitter 1120 may be collocated with a receiver 1110 in a transceiver module. For example, the transmitter 1120 may be an example of aspects of the transceiver 1420 described with reference to FIG. 14. The transmitter 1120 may utilize a single antenna or a set of antennas.

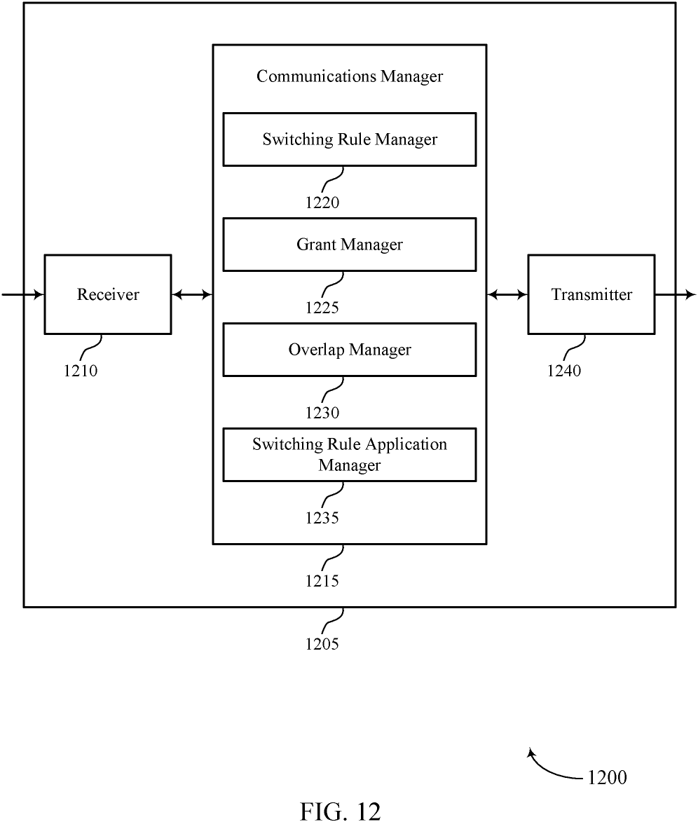

FIG. 12 shows a block diagram 1200 of a device 1205 that supports reference signal dropping with regards to high priority channel collisions in accordance with aspects of the present disclosure. The device 1205 may be an example of aspects of a device 1105, or a base station 105 as described herein. The device 1205 may include a receiver 1210, a communications manager 1215, and a transmitter 1240. The device 1205 may also include a processor. Each of these components may be in communication with one another (e.g., via one or more buses).

The receiver 1210 may receive information such as packets, user data, or control information associated with various information channels (e.g., control channels, data channels, and information related to reference signal dropping with regards to high priority channel collisions, etc.). Information may be passed on to other components of the device 1205. The receiver 1210 may be an example of aspects of the transceiver 1420 described with reference to FIG. 14. The receiver 1210 may utilize a single antenna or a set of antennas.

The communications manager 1215 may be an example of aspects of the communications manager 1115 as described herein. The communications manager 1215 may include a switching rule manager 1220, a grant manager 1225, an overlap manager 1230, and a switching rule application manager 1235. The communications manager 1215 may be an example of aspects of the communications manager 1410 described herein.

The switching rule manager 1220 may identify, for a UE, a switching rule pertaining to either carrier switching or antenna switching associated with the UE performing a reference signal transmission scheduled on a second carrier.

The grant manager 1225 may transmit a grant scheduling a downlink data transmission on a first carrier, the downlink data transmission including a priority level satisfying a priority threshold.

The overlap manager 1230 may determine that the reference signal transmission is scheduled on the second carrier within a time threshold of the downlink data transmission on the first carrier.

The switching rule application manager 1235 may perform the downlink data transmission instead of monitoring for the reference signal transmission based on the switching rule and the priority level of the downlink data transmission satisfying the priority threshold.

The switching rule manager 1220 may transmit, to a UE, a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission.

The grant manager 1225 may transmit a grant scheduling an uplink transmission on the first carrier, the uplink transmission including the priority level satisfying the priority threshold.

The overlap manager 1230 may determine that the reference signal transmission is scheduled on the second carrier within a time threshold of the uplink transmission on the first carrier.

The switching rule application manager 1235 may monitor for one of the reference signal transmission or the uplink transmission based on the switching rule and the priority level of the uplink transmission satisfying the priority threshold.

The transmitter 1240 may transmit signals generated by other components of the device 1205. In some examples, the transmitter 1240 may be collocated with a receiver 1210 in a transceiver module. For example, the transmitter 1240 may be an example of aspects of the transceiver 1420 described with reference to FIG. 14. The transmitter 1240 may utilize a single antenna or a set of antennas.

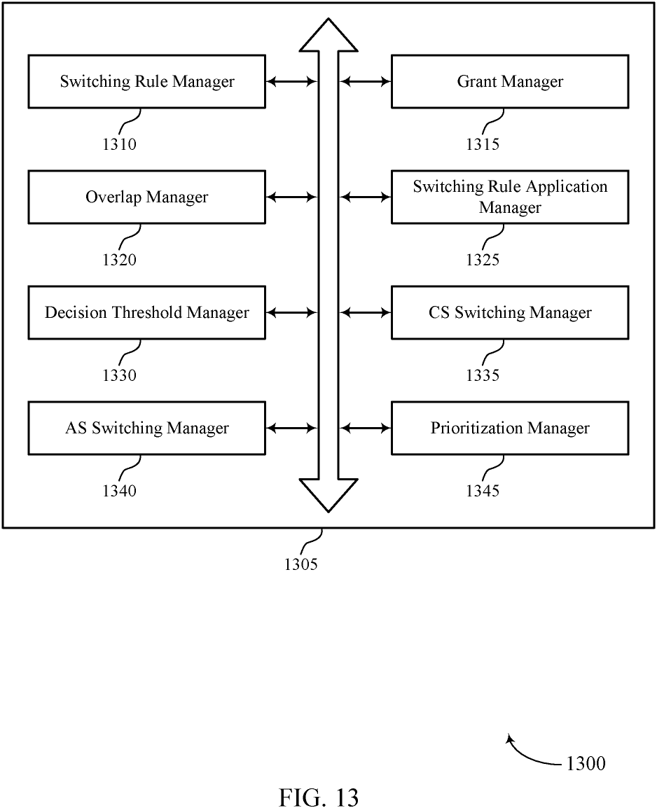

FIG. 13 shows a block diagram 1300 of a communications manager 1305 that supports reference signal dropping with regards to high priority channel collisions in accordance with aspects of the present disclosure. The communications manager 1305 may be an example of aspects of a communications manager 1115, a communications manager 1215, or a communications manager 1410 described herein. The communications manager 1305 may include a switching rule manager 1310, a grant manager 1315, an overlap manager 1320, a switching rule application manager 1325, a decision threshold manager 1330, a CS switching manager 1335, an AS switching manager 1340, and a prioritization manager 1345. Each of these modules may communicate, directly or indirectly, with one another (e.g., via one or more buses).

The switching rule manager 1310 may identify, for a UE, a switching rule pertaining to either carrier switching or antenna switching associated with the UE performing a reference signal transmission scheduled on a second carrier. In some examples, the switching rule manager 1310 may transmit, to a UE, a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission. In some cases, the switching rule includes a carrier switching rule, an antenna switching rule, or both.

The grant manager 1315 may transmit a grant scheduling a downlink data transmission on a first carrier, the downlink data transmission including a priority level satisfying a priority threshold. In some examples, the grant manager 1315 may transmit a grant scheduling an uplink transmission on the first carrier, the uplink transmission including the priority level satisfying the priority threshold.

The overlap manager 1320 may determine that the reference signal transmission is scheduled on the second carrier within a time threshold of the downlink data transmission on the first carrier. In some examples, the overlap manager 1320 may determine that the reference signal transmission is scheduled on the second carrier within a time threshold of the uplink transmission on the first carrier. In some cases, the reference signal transmission includes an SRS transmission.

The switching rule application manager 1325 may perform the downlink data transmission instead of monitoring for the reference signal transmission based on the switching rule and the priority level of the downlink data transmission satisfying the priority threshold. In some examples, the switching rule application manager 1325 may monitor for one of the reference signal transmission or the uplink transmission based on the switching rule and the priority level of the uplink transmission satisfying the priority threshold.

In some examples, the switching rule application manager 1325 may transmit a second grant scheduling a second downlink data transmission on the first carrier, the second downlink data transmission including a second priority level that fails to satisfy the priority threshold. In some examples, the switching rule application manager 1325 may determine that a second reference signal transmission by the UE is scheduled on the second carrier within the time threshold of the second downlink data transmission. In some examples, the switching rule application manager 1325 may monitor for the second reference signal transmission instead of performing the second downlink data transmission based on the switching rule and the second priority level failing to satisfy the priority threshold.

The decision threshold manager 1330 may determine that the grant is received by the UE in advance of the reference signal transmission scheduled on the second carrier by at least a switching decision threshold amount of time, where performing the downlink data transmission instead of monitoring for the reference signal transmission is based on the grant being received before the UE is scheduled to perform the reference signal transmission by at least the switching decision threshold.

The CS switching manager 1335 may transmit an indication that the switching rule pertains to carrier switching between the first carrier and the second carrier for the UE to perform the reference signal transmission on the second carrier. In some examples, the CS switching manager 1335 may identify a switching time associated with the UE switching from the first carrier to the second carrier, from the second carrier back to the first carrier, or both, where determining that the reference signal transmission is scheduled within the time threshold is based on the switching time.

In some examples, the CS switching manager 1335 may determine that at least one of a switching time associated with the UE switching from the first carrier to the second carrier, the reference signal transmission, or a switching time associated with the UE switching from the second carrier to the first carrier after the reference signal transmission is scheduled at least partially overlaps the downlink data transmission, where determining that the reference signal transmission is scheduled within the time threshold is based on the switching time at least partially overlapping with the downlink data transmission.

The AS switching manager 1340 may transmit an indication that the switching rule pertains to antenna switching, where the first carrier and the second carrier are an antenna switching carrier set such that switching of antennas associated with the second carrier causes switching of antennas associated with the first carrier. In some examples, determining that the reference signal transmission includes a set of reference signal transmissions on the second carrier.

In some examples, the AS switching manager 1340 may determine that at least one of the set of reference signal transmissions on the second carrier at least partially overlaps the downlink data transmission, where determining that the reference signal transmission is scheduled within the time threshold is based on the at least one of the set of reference signal transmissions at least partially overlapping with the downlink data transmission. In some examples, determining that the reference signal transmission includes a set of reference signal transmissions on the second carrier.

In some examples, the AS switching manager 1340 may identify a first subset of reference signal transmissions in the set of reference signal transmissions that are scheduled in non-overlapping resources of the downlink data transmission. In some examples, identifying a second subset of reference signal transmissions in the set of reference signal transmissions that are scheduled in at least partially overlapping resources of the downlink data transmission, where performing the downlink data transmission instead of monitoring for the reference signal transmission includes monitoring for the first subset of reference signal transmissions but refraining from monitoring for the second subset of reference signal transmissions.

The prioritization manager 1345 may prioritize, based on the switching rule and the priority level of the uplink transmission the priority threshold, the reference signal transmission on the second carrier over the uplink transmission on the first carrier. In some examples, the prioritization manager 1345 may prioritize, based on the switching rule and the priority level of the uplink transmission satisfying the priority threshold, the uplink transmission on the first carrier over the reference signal transmission on the second carrier.

FIG. 14 shows a diagram of a system 1400 including a device 1405 that supports reference signal dropping with regards to high priority channel collisions in accordance with aspects of the present disclosure. The device 1405 may be an example of or include the components of device 1105, device 1205, or a base station 105 as described herein. The device 1405 may include components for bi-directional voice and data communications including components for transmitting and receiving communications, including a communications manager 1410, a network communications manager 1415, a transceiver 1420, an antenna 1425, memory 1430, a processor 1440, and an inter-station communications manager 1445. These components may be in electronic communication via one or more buses (e.g., bus 1450).

The communications manager 1410 may identify, for a UE, a switching rule pertaining to either carrier switching or antenna switching associated with the UE performing a reference signal transmission scheduled on a second carrier, transmit a grant scheduling a downlink data transmission on a first carrier, the downlink data transmission including a priority level satisfying a priority threshold, determine that the reference signal transmission is scheduled on the second carrier within a time threshold of the downlink data transmission on the first carrier, and perform the downlink data transmission instead of monitoring for the reference signal transmission based on the switching rule and the priority level of the downlink data transmission satisfying the priority threshold.

The communications manager 1410 may also transmit, to a UE, a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission, transmit a grant scheduling an uplink transmission on the first carrier, the uplink transmission including the priority level satisfying the priority threshold, determine that the reference signal transmission is scheduled on the second carrier within a time threshold of the uplink transmission on the first carrier, and monitor for one of the reference signal transmission or the uplink transmission based on the switching rule and the priority level of the uplink transmission satisfying the priority threshold.

The network communications manager 1415 may manage communications with the core network (e.g., via one or more wired backhaul links). For example, the network communications manager 1415 may manage the transfer of data communications for client devices, such as one or more UEs 115.

The transceiver 1420 may communicate bi-directionally, via one or more antennas, wired, or wireless links as described above. For example, the transceiver 1420 may represent a wireless transceiver and may communicate bi-directionally with another wireless transceiver. The transceiver 1420 may also include a modem to modulate the packets and provide the modulated packets to the antennas for transmission, and to demodulate packets received from the antennas.

In some cases, the wireless device may include a single antenna 1425. However, in some cases the device may have more than one antenna 1425, which may be capable of concurrently transmitting or receiving multiple wireless transmissions.

The memory 1430 may include RAM, ROM, or a combination thereof. The memory 1430 may store computer-readable code 1435 including instructions that, when executed by a processor (e.g., the processor 1440) cause the device to perform various functions described herein. In some cases, the memory 1430 may contain, among other things, a BIOS which may control basic hardware or software operation such as the interaction with peripheral components or devices.

The processor 1440 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some cases, a memory controller may be integrated into processor 1440. The processor 1440 may be configured to execute computer-readable instructions stored in a memory (e.g., the memory 1430) to cause the device 1405 to perform various functions (e.g., functions or tasks supporting reference signal dropping with regards to high priority channel collisions).

The inter-station communications manager 1445 may manage communications with other base station 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communication network technology to provide communication between base stations 105.

The code 1435 may include instructions to implement aspects of the present disclosure, including instructions to support wireless communications. The code 1435 may be stored in a non-transitory computer-readable medium such as system memory or other type of memory. In some cases, the code 1435 may not be directly executable by the processor 1440 but may cause a computer (e.g., when compiled and executed) to perform functions described herein.

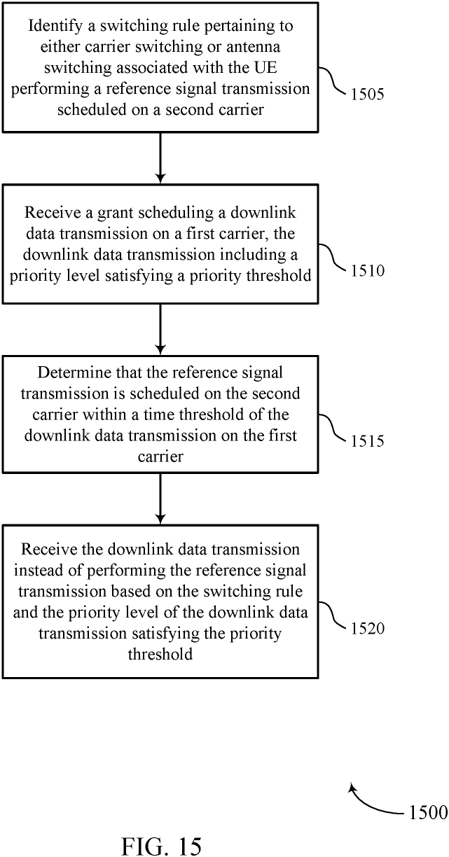

FIG. 15 shows a flowchart illustrating a method 1500 that supports reference signal dropping with regards to high priority channel collisions in accordance with aspects of the present disclosure. The operations of method 1500 may be implemented by a UE 115 or its components as described herein. For example, the operations of method 1500 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1505, the UE may identify a switching rule pertaining to either carrier switching or antenna switching associated with the UE performing a reference signal transmission scheduled on a second carrier. The operations of 1505 may be performed according to the methods described herein. In some examples, aspects of the operations of 1505 may be performed by a switching rule manager as described with reference to FIGS. 7 through 10.

At 1510, the UE may receive a grant scheduling a downlink data transmission on a first carrier, the downlink data transmission including a priority level satisfying a priority threshold. The operations of 1510 may be performed according to the methods described herein. In some examples, aspects of the operations of 1510 may be performed by a grant manager as described with reference to FIGS. 7 through 10.

At 1515, the UE may determine that the reference signal transmission is scheduled on the second carrier within a time threshold of the downlink data transmission on the first carrier. The operations of 1515 may be performed according to the methods described herein. In some examples, aspects of the operations of 1515 may be performed by an overlap manager as described with reference to FIGS. 7 through 10.

At 1520, the UE may receive the downlink data transmission instead of performing the reference signal transmission based on the switching rule and the priority level of the downlink data transmission satisfying the priority threshold. The operations of 1520 may be performed according to the methods described herein. In some examples, aspects of the operations of 1520 may be performed by a switching rule application manager as described with reference to FIGS. 7 through 10.

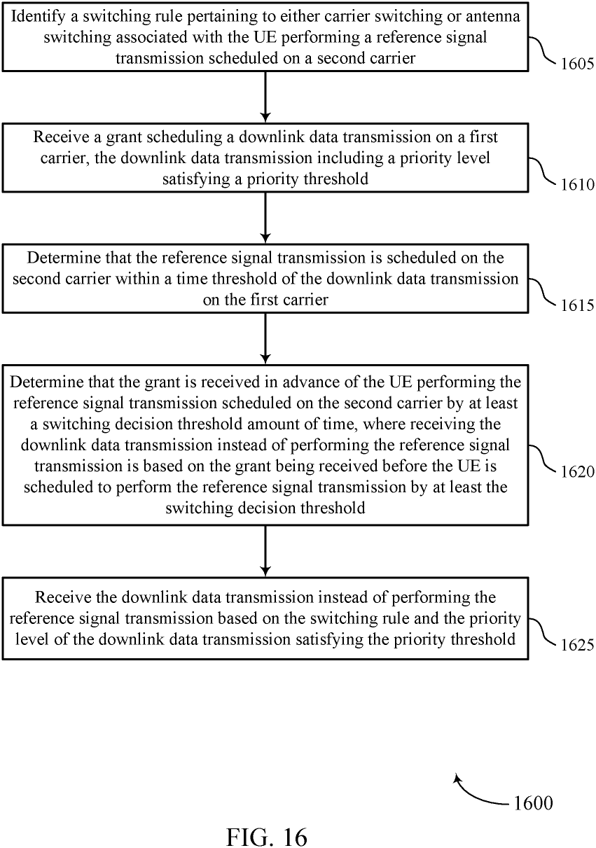

FIG. 16 shows a flowchart illustrating a method 1600 that supports reference signal dropping with regards to high priority channel collisions in accordance with aspects of the present disclosure. The operations of method 1600 may be implemented by a UE 115 or its components as described herein. For example, the operations of method 1600 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1605, the UE may identify a switching rule pertaining to either carrier switching or antenna switching associated with the UE performing a reference signal transmission scheduled on a second carrier. The operations of 1605 may be performed according to the methods described herein. In some examples, aspects of the operations of 1605 may be performed by a switching rule manager as described with reference to FIGS. 7 through 10.

At 1610, the UE may receive a grant scheduling a downlink data transmission on a first carrier, the downlink data transmission including a priority level satisfying a priority threshold. The operations of 1610 may be performed according to the methods described herein. In some examples, aspects of the operations of 1610 may be performed by a grant manager as described with reference to FIGS. 7 through 10.

At 1615, the UE may determine that the reference signal transmission is scheduled on the second carrier within a time threshold of the downlink data transmission on the first carrier. The operations of 1615 may be performed according to the methods described herein. In some examples, aspects of the operations of 1615 may be performed by an overlap manager as described with reference to FIGS. 7 through 10.

At 1620, the UE may determine that the grant is received in advance of the UE performing the reference signal transmission scheduled on the second carrier by at least a switching decision threshold amount of time, where receiving the downlink data transmission instead of performing the reference signal transmission is based on the grant being received before the UE is scheduled to perform the reference signal transmission by at least the switching decision threshold. The operations of 1620 may be performed according to the methods described herein. In some examples, aspects of the operations of 1620 may be performed by a decision threshold manager as described with reference to FIGS. 7 through 10.

At 1625, the UE may receive the downlink data transmission instead of performing the reference signal transmission based on the switching rule and the priority level of the downlink data transmission satisfying the priority threshold. The operations of 1625 may be performed according to the methods described herein. In some examples, aspects of the operations of 1625 may be performed by a switching rule application manager as described with reference to FIGS. 7 through 10.

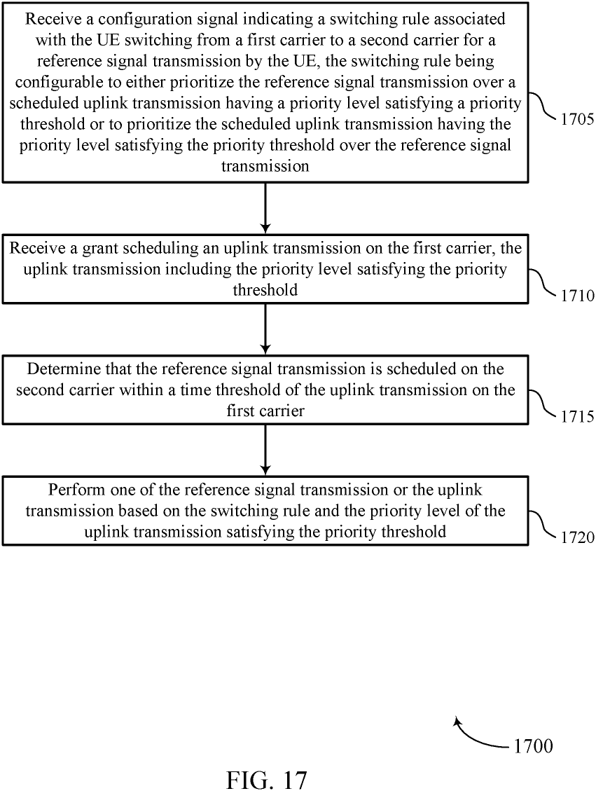

FIG. 17 shows a flowchart illustrating a method 1700 that supports reference signal dropping with regards to high priority channel collisions in accordance with aspects of the present disclosure. The operations of method 1700 may be implemented by a UE 115 or its components as described herein. For example, the operations of method 1700 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1705, the UE may receive a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission. The operations of 1705 may be performed according to the methods described herein. In some examples, aspects of the operations of 1705 may be performed by a switching rule manager as described with reference to FIGS. 7 through 10.

At 1710, the UE may receive a grant scheduling an uplink transmission on the first carrier, the uplink transmission including the priority level satisfying the priority threshold. The operations of 1710 may be performed according to the methods described herein. In some examples, aspects of the operations of 1710 may be performed by a grant manager as described with reference to FIGS. 7 through 10.

At 1715, the UE may determine that the reference signal transmission is scheduled on the second carrier within a time threshold of the uplink transmission on the first carrier. The operations of 1715 may be performed according to the methods described herein. In some examples, aspects of the operations of 1715 may be performed by an overlap manager as described with reference to FIGS. 7 through 10.

At 1720, the UE may perform one of the reference signal transmission or the uplink transmission based on the switching rule and the priority level of the uplink transmission satisfying the priority threshold. The operations of 1720 may be performed according to the methods described herein. In some examples, aspects of the operations of 1720 may be performed by a switching rule application manager as described with reference to FIGS. 7 through 10.

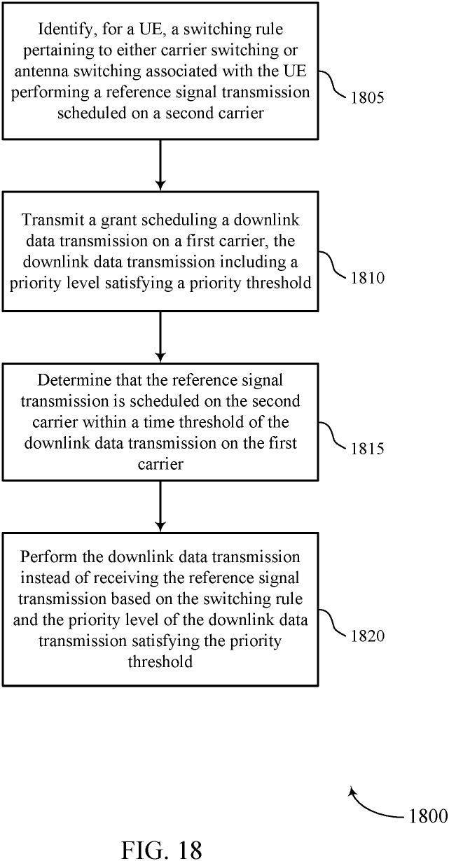

FIG. 18 shows a flowchart illustrating a method 1800 that supports reference signal dropping with regards to high priority channel collisions in accordance with aspects of the present disclosure. The operations of method 1800 may be implemented by a base station 105 or its components as described herein. For example, the operations of method 1800 may be performed by a communications manager as described with reference to FIGS. 11 through 14. In some examples, a base station may execute a set of instructions to control the functional elements of the base station to perform the functions described below. Additionally or alternatively, a base station may perform aspects of the functions described below using special-purpose hardware.

At 1805, the base station may identify, for a UE, a switching rule pertaining to either carrier switching or antenna switching associated with the UE performing a reference signal transmission scheduled on a second carrier. The operations of 1805 may be performed according to the methods described herein. In some examples, aspects of the operations of 1805 may be performed by a switching rule manager as described with reference to FIGS. 11 through 14.

At 1810, the base station may transmit a grant scheduling a downlink data transmission on a first carrier, the downlink data transmission including a priority level satisfying a priority threshold. The operations of 1810 may be performed according to the methods described herein. In some examples, aspects of the operations of 1810 may be performed by a grant manager as described with reference to FIGS. 11 through 14.

At 1815, the base station may determine that the reference signal transmission is scheduled on the second carrier within a time threshold of the downlink data transmission on the first carrier. The operations of 1815 may be performed according to the methods described herein. In some examples, aspects of the operations of 1815 may be performed by an overlap manager as described with reference to FIGS. 11 through 14.

At 1820, the base station may perform the downlink data transmission instead of monitoring for the reference signal transmission based on the switching rule and the priority level of the downlink data transmission satisfying the priority threshold. The operations of 1820 may be performed according to the methods described herein. In some examples, aspects of the operations of 1820 may be performed by a switching rule application manager as described with reference to FIGS. 11 through 14.

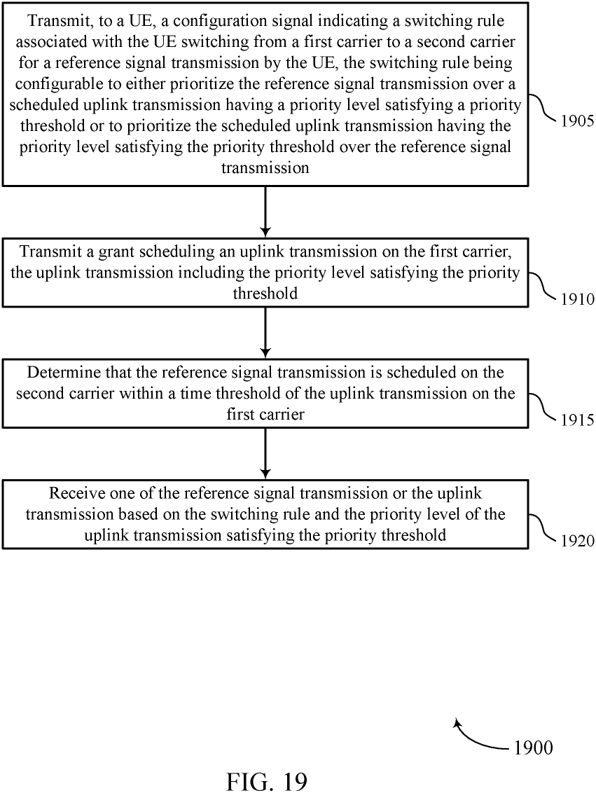

FIG. 19 shows a flowchart illustrating a method 1900 that supports reference signal dropping with regards to high priority channel collisions in accordance with aspects of the present disclosure. The operations of method 1900 may be implemented by a base station 105 or its components as described herein. For example, the operations of method 1900 may be performed by a communications manager as described with reference to FIGS. 11 through 14. In some examples, a base station may execute a set of instructions to control the functional elements of the base station to perform the functions described below. Additionally or alternatively, a base station may perform aspects of the functions described below using special-purpose hardware.

At 1905, the base station may transmit, to a UE, a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission. The operations of 1905 may be performed according to the methods described herein. In some examples, aspects of the operations of 1905 may be performed by a switching rule manager as described with reference to FIGS. 11 through 14.

At 1910, the base station may transmit a grant scheduling an uplink transmission on the first carrier, the uplink transmission including the priority level satisfying the priority threshold. The operations of 1910 may be performed according to the methods described herein. In some examples, aspects of the operations of 1910 may be performed by a grant manager as described with reference to FIGS. 11 through 14.

At 1915, the base station may determine that the reference signal transmission is scheduled on the second carrier within a time threshold of the uplink transmission on the first carrier. The operations of 1915 may be performed according to the methods described herein. In some examples, aspects of the operations of 1915 may be performed by an overlap manager as described with reference to FIGS. 11 through 14.

At 1920, the base station may monitor for one of the reference signal transmission or the uplink transmission based on the switching rule and the priority level of the uplink transmission satisfying the priority threshold. The operations of 1920 may be performed according to the methods described herein. In some examples, aspects of the operations of 1920 may be performed by a switching rule application manager as described with reference to FIGS. 11 through 14.

The following provides an overview of aspects of the present disclosure:

Aspect 1: A method for wireless communication at a UE, comprising: identifying a switching rule pertaining to either carrier switching or antenna switching associated with the UE performing a reference signal transmission scheduled on a second carrier; receiving a grant scheduling a downlink data transmission on a first carrier, the downlink data transmission comprising a priority level satisfying a priority threshold; determining that the reference signal transmission is scheduled on the second carrier within a time threshold of the downlink data transmission on the first carrier; and receiving the downlink data transmission instead of performing the reference signal transmission based at least in part on the switching rule and the priority level of the downlink data transmission satisfying the priority threshold.

Aspect 2: The method of aspect 1, further comprising: determining that the grant is received in advance of the UE performing the reference signal transmission scheduled on the second carrier by at least a switching decision threshold amount of time, wherein receiving the downlink data transmission instead of performing the reference signal transmission is based at least in part on the grant being received before the UE is scheduled to perform the reference signal transmission by at least the switching decision threshold.

Aspect 3: The method of any of aspects 1 through 2, wherein identifying the switching rule comprises: receiving an indication that the switching rule pertains to carrier switching between the first carrier and the second carrier for UE to perform the reference signal transmission on the second carrier.

Aspect 4: The method of aspect 3, further comprising: identifying a switching time associated with the UE switching from the first carrier to the second carrier, from the second carrier back to the first carrier, or both, wherein determining that the reference signal transmission is scheduled within the time threshold is based at least in part on the switching time.

Aspect 5: The method of any of aspects 3 through 4, further comprising: determining that at least one of a switching time associated with the UE switching from the first carrier to the second carrier, the reference signal transmission, or a switching time associated with the UE switching from the second carrier to the first carrier after the reference signal transmission is scheduled at least partially overlaps the downlink data transmission, wherein determining that the reference signal transmission is scheduled within the time threshold is based at least in part on the switching time at least partially overlapping with the downlink data transmission.

Aspect 6: The method of any of aspects 1 through 5, wherein identifying the switching rule comprises: receiving an indication that the switching rule pertains to antenna switching, wherein the first carrier and the second carrier comprise an antenna switching carrier set such that switching of antennas associated with the second carrier causes switching of antennas associated with the first carrier.

Aspect 7: The method of aspect 6, further comprising: determining that the reference signal transmission comprises a set of reference signal transmissions on the second carrier; and determining that at least one of the set of reference signal transmissions on the second carrier at least partially overlaps the downlink data transmission, wherein determining that the reference signal transmission is scheduled within the time threshold is based at least in part on the at least one of the set of reference signal transmissions at least partially overlapping with the downlink data transmission.

Aspect 8: The method of any of aspects 6 through 7, further comprising: determining that the reference signal transmission comprises a set of reference signal transmissions on the second carrier; identifying a first subset of reference signal transmissions in the set of reference signal transmissions that are scheduled in non-overlapping resources of the downlink data transmission; and identifying a second subset of reference signal transmissions in the set of reference signal transmissions that are scheduled in at least partially overlapping resources of the downlink data transmission, wherein receiving the downlink data transmission instead of performing the reference signal transmission comprises performing the first subset of reference signal transmissions but refraining from performing the second subset of reference signal transmissions.

Aspect 9: The method of any of aspects 1 through 8, further comprising: receiving a second grant scheduling a second downlink data transmission on the first carrier, the second downlink data transmission comprising a second priority level that fails to satisfy the priority threshold; determining that a second reference signal transmission is scheduled on the second carrier within the time threshold of the second downlink data transmission; and performing the second reference signal transmission instead of performing the second downlink data transmission based at least in part on the switching rule and the second priority level failing to satisfy the priority threshold.

Aspect 10: The method of any of aspects 1 through 9, wherein the switching rule comprises a carrier switching rule, an antenna switching rule, or both.

Aspect 11: The method of any of aspects 1 through 10, wherein the reference signal transmission comprises a sounding reference signal transmission.

Aspect 12: A method for wireless communication at a UE, comprising: receiving a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission; receiving a grant scheduling an uplink transmission on the first carrier, the uplink transmission comprising the priority level satisfying the priority threshold; determining that the reference signal transmission is scheduled on the second carrier within a time threshold of the uplink transmission on the first carrier; and performing one of the reference signal transmission or the uplink transmission based at least in part on the switching rule and the priority level of the uplink transmission satisfying the priority threshold.

Aspect 13: The method of aspect 12, further comprising: prioritizing, based at least in part on the switching rule and the priority level of the uplink transmission satisfying the priority threshold, the reference signal transmission on the second carrier over the uplink transmission on the first carrier.

Aspect 14: The method of any of aspects 12 through 13, further comprising: prioritizing, based at least in part on the switching rule and the priority level of the uplink transmission satisfying the priority threshold, the uplink transmission on the first carrier over the reference signal transmission on the second carrier.

Aspect 15: The method of any of aspects 12 through 14, wherein the reference signal transmission comprises a sounding reference signal transmission.

Aspect 16: A method for wireless communication at a base station, comprising: identifying, for a UE, a switching rule pertaining to either carrier switching or antenna switching associated with the UE performing a reference signal transmission scheduled on a second carrier; transmitting a grant scheduling a downlink data transmission on a first carrier, the downlink data transmission comprising a priority level satisfying a priority threshold; determining that the reference signal transmission is scheduled on the second carrier within a time threshold of the downlink data transmission on the first carrier; and performing the downlink data transmission instead of monitoring for the reference signal transmission based at least in part on the switching rule and the priority level of the downlink data transmission satisfying the priority threshold.

Aspect 17: The method of aspect 16, further comprising: determining that the grant is received by the UE in advance of the reference signal transmission scheduled on the second carrier by at least a switching decision threshold amount of time, wherein performing the downlink data transmission instead of monitoring for the reference signal transmission is based at least in part on the grant being received before the UE is scheduled to perform the reference signal transmission by at least the switching decision threshold.

Aspect 18: The method of any of aspects 16 through 17, further comprising: transmitting an indication that the switching rule pertains to carrier switching between the first carrier and the second carrier for the UE to perform the reference signal transmission on the second carrier.

Aspect 19: The method of aspect 18, further comprising: identifying a switching time associated with the UE switching from the first carrier to the second carrier, from the second carrier back to the first carrier, or both, wherein determining that the reference signal transmission is scheduled within the time threshold is based at least in part on the switching time.

Aspect 20: The method of any of aspects 18 through 19, further comprising: determining that at least one of a switching time associated with the UE switching from the first carrier to the second carrier, the reference signal transmission, or a switching time associated with the UE switching from the second carrier to the first carrier after the reference signal transmission is scheduled at least partially overlaps the downlink data transmission, wherein determining that the reference signal transmission is scheduled within the time threshold is based at least in part on the switching time at least partially overlapping with the downlink data transmission.

Aspect 21: The method of any of aspects 16 through 20, wherein identifying the switching rule comprises: transmitting an indication that the switching rule pertains to antenna switching, wherein the first carrier and the second carrier are an antenna switching carrier set such that switching of antennas associated with the second carrier causes switching of antennas associated with the first carrier.

Aspect 22: The method of aspect 21, further comprising: determining that the reference signal transmission comprises a set of reference signal transmissions on the second carrier; and determining that at least one of the set of reference signal transmissions on the second carrier at least partially overlaps the downlink data transmission, wherein determining that the reference signal transmission is scheduled within the time threshold is based at least in part on the at least one of the set of reference signal transmissions at least partially overlapping with the downlink data transmission.

Aspect 23: The method of any of aspects 21 through 22, further comprising: determining that the reference signal transmission comprises a set of reference signal transmissions on the second carrier; identifying a first subset of reference signal transmissions in the set of reference signal transmissions that are scheduled in non-overlapping resources of the downlink data transmission; and identifying a second subset of reference signal transmissions in the set of reference signal transmissions that are scheduled in at least partially overlapping resources of the downlink data transmission, wherein performing the downlink data transmission instead of monitoring for the reference signal transmission comprises monitoring for the first subset of reference signal transmissions but refraining from monitoring for the second subset of reference signal transmissions.

Aspect 24: The method of any of aspects 16 through 23, further comprising: transmitting a second grant scheduling a second downlink data transmission on the first carrier, the second downlink data transmission comprising a second priority level that fails to satisfy the priority threshold; determining that a second reference signal transmission by the UE is scheduled on the second carrier within the time threshold of the second downlink data transmission; and monitoring for the second reference signal transmission instead of performing the second downlink data transmission based at least in part on the switching rule and the second priority level failing to satisfy the priority threshold.

Aspect 25: The method of any of aspects 16 through 24, wherein the switching rule comprises a carrier switching rule, an antenna switching rule, or both.

Aspect 26: The method of any of aspects 16 through 25, wherein the reference signal transmission comprises a sounding reference signal transmission.

Aspect 27: A method for wireless communication at a base station, comprising: transmitting, to a UE, a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission; transmitting a grant scheduling an uplink transmission on the first carrier, the uplink transmission comprising the priority level satisfying the priority threshold; determining that the reference signal transmission is scheduled on the second carrier within a time threshold of the uplink transmission on the first carrier; and monitoring for one of the reference signal transmission or the uplink transmission based at least in part on the switching rule and the priority level of the uplink transmission satisfying the priority threshold.

Aspect 28: The method of aspect 27, further comprising: prioritizing, based at least in part on the switching rule and the priority level of the uplink transmission the priority threshold, the reference signal transmission on the second carrier over the uplink transmission on the first carrier.

Aspect 29: The method of any of aspects 27 through 28, further comprising: prioritizing, based at least in part on the switching rule and the priority level of the uplink transmission satisfying the priority threshold, the uplink transmission on the first carrier over the reference signal transmission on the second carrier.

Aspect 30: The method of any of aspects 27 through 29, wherein the reference signal transmission comprises a sounding reference signal transmission.

Aspect 31: An apparatus for wireless communication at a UE, comprising a processor; memory coupled with the processor; and instructions stored in the memory and executable by the processor to cause the apparatus to perform a method of any of aspects 1 through 11.

Aspect 32: An apparatus for wireless communication at a UE, comprising at least one means for performing a method of any of aspects 1 through 11.

Aspect 33: A non-transitory computer-readable medium storing code for wireless communication at a UE, the code comprising instructions executable by a processor to perform a method of any of aspects 1 through 11.

Aspect 34: An apparatus for wireless communication at a UE, comprising a processor; memory coupled with the processor; and instructions stored in the memory and executable by the processor to cause the apparatus to perform a method of any of aspects 12 through 15.

Aspect 35: An apparatus for wireless communication at a UE, comprising at least one means for performing a method of any of aspects 12 through 15.

Aspect 36: A non-transitory computer-readable medium storing code for wireless communication at a UE, the code comprising instructions executable by a processor to perform a method of any of aspects 12 through 15.

Aspect 37: An apparatus for wireless communication at a base station, comprising a processor; memory coupled with the processor; and instructions stored in the memory and executable by the processor to cause the apparatus to perform a method of any of aspects 16 through 26.

Aspect 38: An apparatus for wireless communication at a base station, comprising at least one means for performing a method of any of aspects 16 through 26.

Aspect 39: A non-transitory computer-readable medium storing code for wireless communication at a base station, the code comprising instructions executable by a processor to perform a method of any of aspects 16 through 26.

Aspect 40: An apparatus for wireless communication at a base station, comprising a processor; memory coupled with the processor; and instructions stored in the memory and executable by the processor to cause the apparatus to perform a method of any of aspects 27 through 30.

Aspect 41: An apparatus for wireless communication at a base station, comprising at least one means for performing a method of any of aspects 27 through 30.

Aspect 42: A non-transitory computer-readable medium storing code for wireless communication at a base station, the code comprising instructions executable by a processor to perform a method of any of aspects 27 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication at a user equipment (UE), comprising:
a processor,
memory coupled with the processor; and
instructions stored in the memory and executable by the processor to cause the apparatus to:
identify a switching rule pertaining to either carrier switching or antenna switching associated with the UE performing a reference signal transmission scheduled on a second carrier;
receive a grant scheduling a downlink data transmission on a first carrier, the downlink data transmission comprising a priority level satisfying a priority threshold;
determine that the reference signal transmission is scheduled on the second carrier within a time threshold of the downlink data transmission on the first carrier; and
receive the downlink data transmission instead of performing the reference signal transmission based at least in part on the switching rule and the priority level of the downlink data transmission satisfying the priority threshold.

2. The apparatus of claim 1, wherein the instructions are further executable by the processor to cause the apparatus to:
determine that the grant is received in advance of the UE performing the reference signal transmission scheduled on the second carrier by at least a switching decision threshold amount of time, wherein receiving the downlink data transmission instead of performing the reference signal transmission is based at least in part on the grant being received before the UE is scheduled to perform the reference signal transmission by at least the switching decision threshold.

3. The apparatus of claim 1, wherein the instructions to identify the switching rule are executable by the processor to cause the apparatus to:
receive an indication that the switching rule pertains to carrier switching between the first carrier and the second carrier for UE to perform the reference signal transmission on the second carrier.

4. The apparatus of claim 3, wherein the instructions are further executable by the processor to cause the apparatus to:
identify a switching time associated with the UE switching from the first carrier to the second carrier, from the second carrier back to the first carrier, or both, wherein determining that the reference signal transmission is scheduled within the time threshold is based at least in part on the switching time.

5. The apparatus of claim 3, wherein the instructions are further executable by the processor to cause the apparatus to:
determine that at least one of a switching time associated with the UE switching from the first carrier to the second carrier, the reference signal transmission, or a switching time associated with the UE switching from the second carrier to the first carrier after the reference signal transmission is scheduled at least partially overlaps the downlink data transmission, wherein determining that the reference signal transmission is scheduled within the time threshold is based at least in part on the switching time at least partially overlapping with the downlink data transmission.

6. The apparatus of claim 1, wherein the instructions to identify the switching rule are executable by the processor to cause the apparatus to:
receive an indication that the switching rule pertains to antenna switching, wherein the first carrier and the second carrier comprise an antenna switching carrier set such that switching of antennas associated with the second carrier causes switching of antennas associated with the first carrier.

7. The apparatus of claim 6, wherein the instructions are further executable by the processor to cause the apparatus to:
determine that the reference signal transmission comprises a set of reference signal transmissions on the second carrier; and
determine that at least one of the set of reference signal transmissions on the second carrier at least partially overlaps the downlink data transmission, wherein determining that the reference signal transmission is scheduled within the time threshold is based at least in part on the at least one of the set of reference signal transmissions at least partially overlapping with the downlink data transmission.

8. The apparatus of claim 6, wherein the instructions are further executable by the processor to cause the apparatus to:
determine that the reference signal transmission comprises a set of reference signal transmissions on the second carrier;
identify a first subset of reference signal transmissions in the set of reference signal transmissions that are scheduled in non-overlapping resources of the downlink data transmission; and
the instructions to identify a second subset of reference signal transmissions in the set of reference signal transmissions that are scheduled in at least partially overlapping resources of the downlink data transmission, wherein receiving the downlink data transmission instead of performing the reference signal transmission are executable by the processor to cause the apparatus to perform the first subset of reference signal transmissions but refraining from performing the second subset of reference signal transmissions.

9. The apparatus of claim 1, wherein the instructions are further executable by the processor to cause the apparatus to:
receive a second grant scheduling a second downlink data transmission on the first carrier, the second downlink data transmission comprising a second priority level that fails to satisfy the priority threshold;
determine that a second reference signal transmission is scheduled on the second carrier within the time threshold of the second downlink data transmission; and
perform the second reference signal transmission instead of performing the second downlink data transmission based at least in part on the switching rule and the second priority level failing to satisfy the priority threshold.

10. The apparatus of claim 1, wherein the switching rule comprises a carrier switching rule, an antenna switching rule, or both.

11. The apparatus of claim 1, wherein the reference signal transmission comprises a sounding reference signal transmission.

12. An apparatus for wireless communication at a user equipment (UE), comprising:
a processor,
memory coupled with the processor; and
instructions stored in the memory and executable by the processor to cause the apparatus to:
receive a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission;
receive a grant scheduling an uplink transmission on the first carrier, the uplink transmission comprising the priority level satisfying the priority threshold;
determine that the reference signal transmission is scheduled on the second carrier within a time threshold of the uplink transmission on the first carrier; and
perform one of the reference signal transmission or the uplink transmission based at least in part on the switching rule and the priority level of the uplink transmission satisfying the priority threshold.

13. The apparatus of claim 12, wherein the instructions are further executable by the processor to cause the apparatus to:
prioritize, based at least in part on the switching rule and the priority level of the uplink transmission satisfying the priority threshold, the reference signal transmission on the second carrier over the uplink transmission on the first carrier.

14. The apparatus of claim 12, wherein the instructions are further executable by the processor to cause the apparatus to:
prioritize, based at least in part on the switching rule and the priority level of the uplink transmission satisfying the priority threshold, the uplink transmission on the first carrier over the reference signal transmission on the second carrier.

15. The apparatus of claim 12, wherein the reference signal transmission comprises a sounding reference signal transmission.

16. A method for wireless communication at a user equipment (UE), comprising:
identifying a switching rule pertaining to either carrier switching or antenna switching associated with the UE performing a reference signal transmission scheduled on a second carrier;
receiving a grant scheduling a downlink data transmission on a first carrier, the downlink data transmission comprising a priority level satisfying a priority threshold;
determining that the reference signal transmission is scheduled on the second carrier within a time threshold of the downlink data transmission on the first carrier; and
receiving the downlink data transmission instead of performing the reference signal transmission based at least in part on the switching rule and the priority level of the downlink data transmission satisfying the priority threshold.

17. The method of claim 16, further comprising:
determining that the grant is received in advance of the UE performing the reference signal transmission scheduled on the second carrier by at least a switching decision threshold amount of time, wherein receiving the downlink data transmission instead of performing the reference signal transmission is based at least in part on the grant being received before the UE is scheduled to perform the reference signal transmission by at least the switching decision threshold.

18. The method of claim 16, wherein identifying the switching rule comprises:
receiving an indication that the switching rule pertains to carrier switching between the first carrier and the second carrier for UE to perform the reference signal transmission on the second carrier.

19. The method of claim 18, further comprising:
identifying a switching time associated with the UE switching from the first carrier to the second carrier, from the second carrier back to the first carrier, or both, wherein determining that the reference signal transmission is scheduled within the time threshold is based at least in part on the switching time.

20. The method of claim 18, further comprising:
determining that at least one of a switching time associated with the UE switching from the first carrier to the second carrier, the reference signal transmission, or a switching time associated with the UE switching from the second carrier to the first carrier after the reference signal transmission is scheduled at least partially overlaps the downlink data transmission, wherein determining that the reference signal transmission is scheduled within the time threshold is based at least in part on the switching time at least partially overlapping with the downlink data transmission.

21. The method of claim 16, wherein identifying the switching rule comprises:
receiving an indication that the switching rule pertains to antenna switching, wherein the first carrier and the second carrier comprise an antenna switching carrier set such that switching of antennas associated with the second carrier causes switching of antennas associated with the first carrier.

22. The method of claim 21, further comprising:
determining that the reference signal transmission comprises a set of reference signal transmissions on the second carrier; and
determining that at least one of the set of reference signal transmissions on the second carrier at least partially overlaps the downlink data transmission, wherein determining that the reference signal transmission is scheduled within the time threshold is based at least in part on the at least one of the set of reference signal transmissions at least partially overlapping with the downlink data transmission.

23. The method of claim 21, further comprising:
determining that the reference signal transmission comprises a set of reference signal transmissions on the second carrier;
identifying a first subset of reference signal transmissions in the set of reference signal transmissions that are scheduled in non-overlapping resources of the downlink data transmission; and
identifying a second subset of reference signal transmissions in the set of reference signal transmissions that are scheduled in at least partially overlapping resources of the downlink data transmission, wherein receiving the downlink data transmission instead of performing the reference signal transmission comprises performing the first subset of reference signal transmissions but refraining from performing the second subset of reference signal transmissions.

24. The method of claim 16, further comprising:
receiving a second grant scheduling a second downlink data transmission on the first carrier, the second downlink data transmission comprising a second priority level that fails to satisfy the priority threshold;
determining that a second reference signal transmission is scheduled on the second carrier within the time threshold of the second downlink data transmission; and
performing the second reference signal transmission instead of performing the second downlink data transmission based at least in part on the switching rule and the second priority level failing to satisfy the priority threshold.

25. The method of claim 16, wherein the switching rule comprises a carrier switching rule, an antenna switching rule, or both.

26. The method of claim 16, wherein the reference signal transmission comprises a sounding reference signal transmission.

27. A method for wireless communication at a user equipment (UE), comprising:
receiving a configuration signal indicating a switching rule associated with the UE switching from a first carrier to a second carrier for a reference signal transmission by the UE, the switching rule being configurable to either prioritize the reference signal transmission over a scheduled uplink transmission having a priority level satisfying a priority threshold or to prioritize the scheduled uplink transmission having the priority level satisfying the priority threshold over the reference signal transmission;
receiving a grant scheduling an uplink transmission on the first carrier, the uplink transmission comprising the priority level satisfying the priority threshold;
determining that the reference signal transmission is scheduled on the second carrier within a time threshold of the uplink transmission on the first carrier; and
performing one of the reference signal transmission or the uplink transmission based at least in part on the switching rule and the priority level of the uplink transmission satisfying the priority threshold.

28. The method of claim 27, further comprising:
prioritizing, based at least in part on the switching rule and the priority level of the uplink transmission satisfying the priority threshold, the reference signal transmission on the second carrier over the uplink transmission on the first carrier.

29. The method of claim 27, further comprising:
prioritizing, based at least in part on the switching rule and the priority level of the uplink transmission satisfying the priority threshold, the uplink transmission on the first carrier over the reference signal transmission on the second carrier.

30. The method of claim 27, wherein the reference signal transmission comprises a sounding reference signal transmission.
